(19) United States
(12) Patent Application Publication
(10) Pub. No.: US 2012/0030702 A1
(43) Pub. Date: Feb. 2, 2012

(54) Digital television broadcasting apparatus and method for providing information in a digital television and internet convergent environment

(76) Inventor: Raymond Anthony Joao, Yonkers, NY (US)

(21) Appl. No.: 13/200,446

(22) Filed: Sep. 23, 2011

Related U.S. Application Data
(62) Division of application No. 12/454,889, filed on May 26, 2009.
(60) Provisional application No. 61/132,633, filed on Jun. 20, 2008.

(51) Int. Cl. H04N 7/10; H04N 7/173

(52) U.S. Cl. 725/32; 725/105

(57) ABSTRACT

A digital television broadcast apparatus, including a database which stores a plurality of news stories or information received or obtained from any number of content providers, a memory device which stores information regarding a request by an individual to receive a personal news report, wherein the personal news report contains one or more news stories associated with a topic or subject specified by the individual, a processor which detects a posting of a news story or news stories in the database, determines if the news story or news stories are associated with the topic or subject specified by the individual, and if the news story or news stories are associated with the topic or subject specified by the individual, generates a personal news report containing the news story or news stories, and a transmitter which transmits the personal news story to a communication device associated with the individual.

### RELATED APPLICATIONS

This application is a divisional application of U.S. patent application Ser. No. 12/454,889, filed May 26, 2009, and entitled “DIGITAL TELEVISION BROADCASTING APPARATUS AND METHOD FOR PROVIDING INFORMATION IN A DIGITAL TELEVISION AND INTERNET CONVERGENT ENVIRONMENT”, the subject matter and teachings of which are hereby incorporated by reference herein in their entirety. U.S. patent application Ser. No. 12/454,889 claims the benefit of the priority of U.S. Provisional Patent Application Ser. No. 61/132,633, filed Jun. 20, 2008, and entitled “DIGITAL TELEVISION BROADCASTING APPARATUS AND METHOD FOR PROVIDING INFORMATION IN A DIGITAL TELEVISION AND INTERNET CONVERGENT ENVIRONMENT”, the subject matter and teachings of which are hereby incorporated by reference herein in their entirety.

### FIELD OF THE INVENTION

The present invention pertains to a digital television broadcasting apparatus and method for providing information in a digital television and/or Internet convergent environment and, in particular, the present invention pertains to a digital television broadcasting apparatus and method, for providing information in a digital television and/or Internet convergent environment, which provides enhanced products and/or services for individual consumers, content providers and/or broadcasters, advertisers and/or marketing entities, ratings entities, and others who or which utilize same.

### BACKGROUND OF THE INVENTION

Television is probably one of the most recognized, widely used, and relied upon, mediums by which information is disseminated in the United States and throughout the rest of the industrialized and western world. Through the years, television and, in particular, broadcast television, has found numerous applications in the fields of communications, entertainment, news dissemination, and/or information dissemination in general, and the list of applications can go on and on.

In spite of the fact that television and, in particular, broadcast television is so widely used and recognized as a leading information dissemination medium, broadcast television systems have many shortcomings in an age when individuals and entities demand information immediately and in an more efficient manner.

Typically, individuals or entities have to rely of news reporting services which typically gather news stories and/or information and disseminate same in a fashion or order which is geared towards maximizing advertising and/or sponsorship revenues. For example, an individual interested in hearing about a particular news story may have to watch the better part of a television news broadcast before that story is presented, if it is presented at all.

Further, some individuals interested in specific topics or subjects of news stories might find that stories of particular interest to them may be gathered by different news reporting services and, therefore, may not be available to them by simply watching one news broadcast service.

Individuals or entities who rely on broadcast television are not the only ones who must deal with the inefficiencies of broadcast television. Advertisers must also deal with the fact that ratings information regarding a program, show, or other content, takes time to collect, process, and quantify, and this results in substantial delays in acquiring ratings information. Further, television broadcasters typically sell their advertising time slots or advertising slots well in advance of a broadcast of a program, show, or other content. In effect, advertisers have to gamble by purchasing advertising time using ratings information which may not be accurate at the time the advertising time is purchased, and once purchased, the advertisers may typically be locked into an advertising time slot or advertising slot regardless of the ratings of a program or show at that particular point in time. Further, any problems which may result from typical delays associated with determining ratings for programs, shows, or other content, can be further compounded by additional delays typically associated with disseminating the ratings information to those interested parties who rely on same.

The inefficiencies associated with obtaining ratings information in broadcast television also have an impact on the television stations and networks which, if they had ratings information regarding their programming sooner, could modify or alter their programming and/or scheduling so as to minimize the negative impact of a poor rating and maximize the impact of a good rating.

In short, broadcast television leaves much to be desired in this day and age when information is needed by the respective individuals or entities, advertisers, and/or television stations and networks who or which need information immediately and/or in a much more efficient manner.

### SUMMARY OF THE INVENTION

The present invention pertains to a digital television broadcasting apparatus and method for providing information in a digital television and/or Internet convergent environment which overcomes the shortcomings of the prior art. The present invention pertains to a digital television broadcasting apparatus and method for providing information in a digital television and/or Internet convergent environment and, in particular, the present invention pertains to a digital television broadcasting apparatus and method which provides information in a digital television and/or Internet convergent environment and which provides enhanced products and/or services for individual consumers, content providers and/or broadcasters, advertisers and/or marketing entities, ratings entities, and others who or which utilize same.

The present invention provides a system and/or a platform, and methods of use therefor, by which content, advertising, marketing materials, and/or ratings information, can be disseminated by or via a digital television broadcasting network, system, or transmission means, by or via the Internet and/or the World Wide Web, and/or by or via a cellular or wireless communications network and/or any other suitable communications network or platform.

The present invention can be utilized to provide a comprehensive news and/or information content database which can store, and/or serve as a global, national, regional, and/or local, repository for, news and/or information which can be received from any one or more of any number of content sources, content providers, or contributing entities or individuals, including, but not limited to, a news service, a news reporting agency, a television station, a radio station, a newspaper, a magazine, a journal, an Internet and/or a World Wide Web content source or provider, a reporter, an author, a research institution or a laboratory, a university, a college, a school and/or any other institution of learning, a journalist, a freelance journalist, and/or an individual or any individual who desires to provide news or information for dissemination via the apparatus and method of the present invention. The news and information stored in the comprehensive news and/or information content database can be transmitted or uploaded to, or stored or deposited into, the comprehensive news and/or information database by any of the herein-described content sources or contributing entities or individuals. The deposited news or information can then be purchased for use or dissemination by any appropriate entity or individual, with payment being made to the respective content source or contributing entity or individual.

In this manner, the present invention provides a comprehensive news and/or information database which can provide a vehicle by which news and/or information can be collected in a global, national, regional, or local, manner, and be made available for use or dissemination by a respective entity or individual anywhere in the World. The comprehensive news and/or information database can also be utilized to sell content and serve as a revenue generation source for the content provider or contributing entity or individual who provides the respective news or information.

The present invention can also be utilized to provide for the creation of, and/or for the sale and/or purchase of, content options and/or content derivatives.

The present invention can also be utilized to provide personal news accounts and personal news reports for individuals or entities. The present invention can provide personal news reports to an individual or entity which can be tailored to the individual's or the entity's specific requests or specified interests. Multiple personal news reports can also be provided to an individual or an entity. For example, an individual may desire to receive a personal news report, which can consist of one or more news stories or information reports, regarding World news, national, regional, or local news, financial, investment, or business, news, health, fitness, or wellness, news, or any other news or information regarding any developments in which the individual or entity is interested or which may be of interest to the individual or entity. A personal news report can be tailored to provide information regarding any area or field of interest of the individual or entity. The personal news report can also contain an advertisement or advertisements.

The present invention can also be utilized to monitor program or information viewership and/or ratings in real-time.

The present invention can also be utilized to provide an advertisement placement functionality whereby advertisement time slots or advertisement slots can be searched, selected, and purchased, in an on-line or electronic commerce environment. The present invention can also be utilized to provide automated advertisement placement in television broadcast programming and/or in any of the other information provided via the apparatus and method of the present invention.

The present invention can also be utilized to process transactions involving the sale and/or purchase of advertising time slots or advertising slots in programming and/or in other information provided by the apparatus and method of the present invention, advertising products and/or services, advertisements, advertising, and/or advertisement locations in provided content. The present invention can also be utilized to provide a clearinghouse for the sale and/or purchase of advertising time slots or advertising slots in programming and/or in other information provided by the apparatus and method of the present invention, advertising products and/or services, advertisements, advertising, and/or advertisement locations in provided content. The present invention, in addition, can be utilized to create a secondary and/or on-line marketplace for the sale and/or purchase of advertising time slots or advertising slots in programming and/or in other information provided by the apparatus and method of the present invention, advertising products and/or services, advertisements, advertising, and/or advertisement locations in provided content.

The present invention can also be utilized to provide for the creation of and/or for the sale and/or purchase of advertising and/or advertisement derivatives, such as, but not limited to, advertisement options and options for advertising time slots or advertising slots in programming and/or in other information provided by the apparatus and method of the present invention, advertising products and/or services, advertisements, advertising, and/or advertisement locations in provided content.

The present invention can also be utilized to facilitate affiliated marketing activities in connection with digital television programming and broadcasts.

The present invention can also be utilized to provide news alerts and/or to provide alerts regarding the availability of various types of information.

The present invention can also provide immediate and/or real-time alerts to television station operators and other content providers described herein regarding changes in ratings and/or ratings reports.

The present invention can be utilized, in any of the herein-described embodiments, in order to provide advertisement-based products and/or services and/or subscription-based products and/or services.

The apparatus of the present invention includes a central processing computer or server computer which provides control over the apparatus and which performs the various processing operations and functions for providing the various services described herein as being provided by the apparatus of the present invention. The central processing computer can be any suitable computer, network computer, or computer system. The central processing computer can be associated with a television station, a television network, a group of television stations, or a group of television networks. The central processing computer can also be associated with a cable television system, a satellite television system, and/or any other system or network which provides television programming to the consumer or business markets. The central processing computer can be associated with a digital television broadcasting network or system, a high definition television (HDTV) broadcasting network or system, a cable television network or system, an Internet Protocol television (IP television) network or system, a satellite or dish television network or system, and/or a conventional television broadcasting system which broadcasts or which can be adapted to broadcast digital television signals.

Any number of central processing computers can be utilized in the apparatus of the present invention in order to perform the operations and/or functions described herein as being provided by the apparatus of the present invention. The central processing computer(s) can be linked to any other central processing computer(s) or may be a stand alone system.

Any given central processing computer may service a particular television market or region, a national market or region, an international market or region, and/or the global market. A central processing computer may also be dedicated to service any one or group of markets. The central processing computer can transmit or broadcast digital television programming, news, information, advertisements, commercials, marketing information, and/or any other suitable information, in a digital television environment.

The apparatus of the present invention can also include a programming input/live fee system which can be connected or linked with the central processing computer and which can transmit live programming to the central processing computer for digital television transmission or digital television broadcast to individual devices which can include, but which are not limited to, an individual's television, an individual's personal computer, an individual's cellular or wireless telephone or personal digital assistant, or any other suitable individual communication device. The programming input/live fee system can, for example, include a television camera, a video recording device, or any other video recording device or system, and any other attendant systems or devices, and can be located at any location, at or in any type of premises, and/or at or in any type of vehicle.

The apparatus of the present invention can also include a news/information content computer which can be connected to or linked with the central processing computer. The news/information content computer can include a database in which news, news stories, news reports, news programming, news video and/or audio information, articles, research findings, reports, text articles, and/or any other information, which can be provided via the present invention, is stored. The information stored in the database of the news/information content computer can be accessed by and/or be provided to the central processing computer for transmission or broadcast, or other dissemination, as described herein. The news, news stories, news reports, news programming, news video and/or audio information, articles, research findings, reports, text articles, and/or any other information, stored in the database of the news/information content computer can be transmitted to the news/information content computer from a content provider communication device and/or from the central processing computer. The news, news stories, news reports, news programming, news video and/or audio information, articles, research findings, reports, text articles, and/or any other information, stored in the database of the news/information content computer can also be input into the news/information content computer via any number of input devices. Any number of news/information content computers can be utilized in the apparatus of the present invention.

The apparatus can also include the aforementioned content provider communication device which can be connected to or linked with the news/information content computer via any communication network described herein as being utilized in connection with the apparatus. The content provider communication device can be used by any news service, news reporting agency, television station, radio station, newspaper, magazine, journal, Internet and/or World Wide Web content source or provider, reporter, author, research institution or laboratory, university, college, school and/or any other institution of learning, journalist, freelance journalist, and/or individual or any individual who desires to provide news or information for dissemination via the apparatus and method of the present invention.

The apparatus can also include a ratings computer which is connected to or linked with the central processing computer. The ratings computer can include a database which stores information regarding various ratings and viewership information for various programming, news programs, television programs, informational programs, entertainment programs, sporting and athletic programs, advertisements, commercials, and/or marketing information, which can be provided in a digital television/Internet environment. Ratings information can be transmitted to the ratings computer from a ratings provider communication device and/or from the central processing computer. Ratings information can also be input into the ratings computer via any number of input devices. Any number of ratings computers can be utilized in the apparatus of the present invention.

The apparatus can also include the aforementioned ratings provider communication device which is connected to or linked with the ratings computer via any communication network described herein as being utilized in connection with the apparatus. The ratings provider communication device can be used by any ratings reporting service or organization, television ratings reporting service or organization, radio ratings reporting service or organization, Internet ratings reporting service or organization, a ratings agency, a television station, a television network, a radio station, an Internet service provider, a search engine company, service, or organization, and/or any other entity or individual from which ratings information may be obtained, in order to transmit ratings information to the ratings computer.

The apparatus of the present invention can also include an advertisement/marketing computer which is connected to or linked with the central processing computer. The advertisement/marketing computer can include a database which stores advertisements, commercials, and/or marketing, materials. The advertisements and/or commercials can include television, Internet, and/or video and audio, commercials, infomercials, video advertisements, video clips, audio advertisements, audio clips, banner advertisements, button advertisements, advertisements which can be placed on web pages and/or on frames surrounding viewed or viewable content, logos, icons, and/or any other information which can be utilized as an advertisement or commercial. The marketing materials can include surveys, questionnaires, and/or any other materials, which can be utilized in performing marketing research, market research, marketing planning and strategic planning, and/or any other information which can be used for gathering marketing information. The information described herein as being stored in the database of the advertisement/marketing computer can be transmitted to the advertisement/marketing computer from an advertisement/marketing provider communication device which can be connected to or linked with the advertisement/marketing computer and/or is transmitted from the central processing computer.

The information described herein as being stored in the database of the advertisement/marketing computer can also be input into the advertisement/marketing computer via any number of input devices. Any number of advertisement/marketing computers can be utilized in the apparatus of the present invention.

The apparatus can also include the aforementioned advertisement/marketing provider communication device which can be connected to or linked with the advertisement/marketing computer via any communication network described herein as being utilized in connection with the apparatus. The advertisement/marketing provider communication device can be used by any advertiser, advertising agency, marketing company, marketing research company, and/or by any entity or individual which or who may be desirous of providing advertisements, advertisement information, commercials, infomercials, video advertisements, video clips, audio advertisements, audio clips, banner advertisements, button advertisements, advertisements which can be placed on web pages and/or on frames surrounding viewed or viewable content, logos, icons, and/or any other information which can be utilized as an advertisement, commercial, marketing materials, surveys, questionnaires, and/or any other materials which can be utilized in performing marketing research, market research, marketing planning and strategic planning, and/or any other information which can be used for gathering marketing information.

The apparatus also includes a television which can receive digital television broadcast signals and which can be associated with or used by any herein-described individual, user, customer, entity, or subscriber, of a television station, television network, group of television stations, group of television networks, cable television provider, and/or satellite or dish television provider, associated with the central processing computer. The television can be a digital television, a high definition television, and/or an interactive television. The television can also have associated therewith a so-call “cable TV box” or “set-top box” and/or a remote control device which allows a user to interact with the television, with the central processing computer, and with the respective television station, television network, group of television stations, group of television networks, cable television provider, and/or satellite or dish television provider, associated with the central processing computer.

A television, in addition to being associated with or used by an individual, user, customer, entity, or subscriber, of the respective television station, television network, group of television stations, group of television networks, cable television provider, and/or satellite or dish television provider, associated with the central processing computer, can also be associated with a respective television station, television network, group of television stations, group of television networks, cable television provider, satellite or dish television provider, associated with the central processing computer, a provider of news content, a provider of ratings information, and/or a provider of advertisements or marketing information.

The television can send signals, data, and/or information, to, and/or receive signals, data, and/or information, from, any one or more of the central processing computers which can or may be utilized, the news/information content computer, the content provider communication device, the ratings computer, the ratings provider communication device, the advertisement/marketing computer, and/or the advertisement/marketing provider computer.

The apparatus also includes a personal computer or personal communication device which is associated with any herein-described individual, user, customer, entity, or subscriber, of a television station, television network, group of television stations, group of television networks, cable television provider, satellite or dish television provider, associated with the central processing computer. The personal computer or personal communication device can also be, or can include, a personal computer, a home computer, a laptop computer, a handheld computer, a personal communication device, a personal communication services device, and/or a watch.

The personal computer or personal communication device can be used to allow a respective individual, user, customer, entity, or subscriber, to interact with the central processing computer(s) and/or the respective television station, television network, group of television stations, group of television networks, cable television provider, and/or satellite or dish television provider, associated with the central processing computer. A personal computer or personal communication device, in addition to being associated with or used by an individual, user, customer, entity, or subscriber, of the respective television station, television network, group of television stations, group of television networks, cable television provider, satellite or dish television provider, associated with the central processing computer, can also be associated with or used by a respective television station, television network, group of television stations, group of television networks, cable television provider, a satellite or dish television provider, associated with the central processing computer, a provider of news content, a provider of ratings information, and/or a provider of advertisements, commercials, or marketing information.

The personal computer or personal communication device can send signals, data, and/or information, to, and/or receive signals, data, and/or information, from, any one or more of the central processing computers, the news/information content computer, the content provider communication device, the ratings computer, the ratings provider communication device, the advertisement/marketing computer, and/or the advertisement/marketing provider computer.

The apparatus also includes a cellular or wireless communication device which is associated with any herein-described individual, user, customer, entity, or subscriber, of a television station, television network, group of television stations, group of television networks, cable television provider, satellite or dish television provider, associated with the central processing computer. The cellular or wireless communication device can also be, or can include, a cellular telephone, a wireless telephone, a mobile telephone, a video telephone, a videophone, a personal digital assistant, a personal communication device, a personal communication services device, and/or a watch. The cellular or wireless communication device can also be used to allow an individual, user, customer, entity, or subscriber, to interact with the central processing computer(s) and/or with any respective television station, television network, group of television stations, group of television networks, cable television provider, and/or satellite or dish television provider, associated with the central processing computer.

The cellular or wireless communication device, in addition to being associated with or used by an individual, user, customer, entity, or subscriber, of the respective television station, television network, group of television stations, group of television networks, cable television provider, and/or satellite or dish television provider, associated with the central processing computer, can also be associated with a respective television station, television network, group of television stations, group of television networks, cable television provider, and/or satellite or dish television provider, associated with the central processing computer, a provider of news content, a provider of ratings information, and/or a provider of advertisements, commercials, or marketing information.

The cellular or wireless communication device can send signals, data, and/or information, to, and/or receive signals, data, and/or information, from, any one or more of the central processing computers, the news/information content computer, the content provider communication device, the ratings computer, the ratings provider communication device, the advertisement/marketing computer, and/or the advertisement/marketing provider computer.

The communications networks and/or systems via, on, or over, which the present invention may be utilized, and via, on, or over, which any of the herein-described devices may communicate with each other, can include any one or combination of telecommunication networks or systems, satellite communication networks or systems, radio communication networks or systems, digital communication networks or systems, digital satellite communication networks or systems, personal communications services networks or systems, cable television networks or systems, satellite or dish television networks or systems, digital television networks or systems, broadband communication networks or systems, radio frequency (RF) networks or systems, satellite radio networks or systems, low earth orbiting satellite (LEOs) networks or systems, as well as via, on, or over, the Internet and/or the World Wide Web, cellular communication networks or systems, wireless communication networks or systems, and/or via, on, or over, any suitable internets and/or intranets.

Each of the central processing computer(s), the programming input/live feed system, the news/information content computer, the ratings computer, the advertisement/marketing computer, the respective provider communication devices, the television(s), the personal computer(s), and/or the cellular or wireless communication device(s), can include a central processing unit (CPU), a random access memory (RAM), a read only memory (ROM), an input device(s), an output(s), a display device(s), a receiver(s), a database(s) for storing information, and a transmitter(s).

As noted herein, the present invention can be utilized to provide a comprehensive news and/or information content database which can store, and/or serve as a global, national, regional, and/or local, repository for, news and/or information which can be received from any one or more of any number of content sources or contributing entities or individuals described herein.

The comprehensive news and/or information database can be located in the database of the central processing computer and/or in the database of the news/information content computer and can include data and/or information regarding accounts for entities and/or individuals which or who can contribute and/or deposit news stories and/or information to the comprehensive news and/or information database as well as accounts for entities and/or individuals which or who can subscribe to the services of the comprehensive news and/or information database in order to obtain news stories and/or other information therefrom. For example, an entity or an individual, such as, for example, a news reporting service or entity or an individual such as, for example, a freelance journalist or other person can establish an account with the apparatus, make contributions of a news story or news stories or other information, and be compensated for the contribution. An entity such as, for example, a television news show, an Internet content provider, a radio program, a magazine, or a newspaper, or any individual or person, can obtain news stories or information which has been deposited in the comprehensive news and/or information database.

The news stories and/or information contributed by the respective contributors may originate from anywhere in the World and can be provided to any herein-described individual, user, customer, entity, or subscriber. In this manner, the present invention can provide a comprehensive news and/or information database wherein news stories and/or information, which originate any where in the World can reside in a single database system for access, use, and/or consumption, by any individual, user, customer, entity, or subscriber, who utilizes the present invention. News stories and/or information can be transmitted to, as well as can be transmitted from, the comprehensive news and/or information database via, on, or over, the Internet and/or the World Wide Web, and/or any other suitable communication network or system. Contributors can be compensated for each contribution made or can be compensated via a retainer arrangement whereby they can be expected to make contributions on a regular basis. Contributors can also be compensated each time a news story or information which they/he/she has contributed is used by, provided to, or obtained by, any an individual, user, customer, entity, or subscriber.

The apparatus, the central processing computer, and/or the news/information content computer, can process any and/or all transactions relating to the comprehensive news and/or information database as well as effect any and/or all financial transactions relating thereto. The apparatus, the central processing computer, and/or the news/information content computer, can, for example, process any and/or all information for making a payment from an individual's, a user's, a customer's, an entity's, or a subscriber's, financial account to a financial account corresponding to the contributor of the news story or information which is accessed, used, or purchased.

An individual, user, customer, entity, or subscriber, which can be or can include a television news show, an Internet content provider, a radio program, a magazine, a newspaper, or any individual or entity, can access the comprehensive news and/or information database, such as by accessing the central processing computer or the news/information content computer via a television, personal computer, and/or cellular or wireless communication device. The individual, user, customer, entity, or subscriber, can then enter a search request which can include search criteria for searching the comprehensive news story or information database by story or information subject or topic, by story or information source or origin, by date, by description, and/or by any other appropriate search criteria, in order to receive one or more news stories or information stored in the comprehensive news and/or information database.

The central processing computer or the news/information content provider computer can thereafter process the entered search request, generate a report containing any news story or stories or information responsive to the search request, and transmit the report containing one of more news stories or information to the television, personal computer, and/or cellular or wireless communication device. The individual, user, customer, entity, or subscriber, can then select the news story or new stories, or information, which it/he/she desires to purchase or utilize. Thereafter, payment for use of the news story or stories, or information, can be made to a financial account associated with the contributor of the news story or information. In the case of a television news show, an Internet content provider, a radio program, a magazine, or a newspaper, or other entity which may have or operate its own central processing computer, then the search request may be transmitted to the news/information content computer via an input device of the respective central processing computer. It is important to note, however, that a television news show, an Internet content provider, a radio program, a magazine, or a newspaper, can also have associated therewith, and can utilize, a television, personal computer, and/or cellular or wireless communication device.

The apparatus of the present invention and/or the comprehensive news and/or information database can also provide real-time, or immediate, alerts to individuals, users, customers, entities, or subscribers, when a news story or stories, or information, of interest to the respective individuals, users, customers, entities, or subscribers, is posted to, or stored in, the comprehensive news and/or information database.

A real-time or immediate news alert or information alert can also be provided to an individual, user, customer, entity, or subscriber. In the case where an individual, user, customer, entity, or subscriber is a television news show, an Internet content provider, a radio program, a magazine, or a newspaper, the herein-described alert message features can be utilized to supplement its other news gathering resources. Also, in the case where the television news show, Internet content provider, radio program, magazine, or newspaper, is the contributor of the news story or information which is the subject of the alert, the respective television news show, Internet content provider, radio program, magazine, or newspaper, can receive compensation for the alert message and/or can provide an advertisement or advertisements in same.

As noted herein, the present invention can also generate and provide personal news reports to individuals, users, customers, entities, or subscribers, which can contain a news story, news stories, or information, of interest to a respective individual, user, customer, entity, or subscriber. An individual, user, customer, entity, or subscriber, can create a personal news account by which to request and receive one or more personal news reports. An individual, user, customer, entity, or subscriber, can request, at any time, to receive a personal news report containing news or information regarding any topic or subject of interest to the respective individual, user, customer, entity, or subscriber. For example, an individual or subscriber interested in receiving a news report pertaining to a development in the financial or investment markets, can request to receive a news report containing a news story or news stories regarding a development in the financial or investment markets. Similarly, an individual or subscriber interested in receiving a news report pertaining to a development in the field of healthcare, medicine, or dentistry, may request to receive a news report containing a news story or news stories regarding a development or developments in the healthcare field, the medical field, or the dental filed. Likewise, an individual or subscriber can request to receive a personal news report on breaking World news, national news, regional news, local news, an emergency broadcast, and/or news or information regarding politics, business, health, fitness, wellness, technology, law, crime, entertainment, travel, living and/or human interest, sports, consumer information, weather, traffic, education, and/or any other topic or subject for which news or information my be reported or be disseminated.

The individual, user, customer, entity, or subscriber, can access the central processing computer and/or the news/information content computer and sign-up to receive personal news reports and can sign-up to receive more than one personal news reports on one or more of a number of topics or subjects. Any of the personal news reports can contain video clips, audio clips, clips containing both audio and video, text, and/or any combination of same. The personal news reports can be transmitted to any one or more of the television, the personal computer, and/or the cellular or wireless communication device, associated with, or used by, the individual, user, customer, entity, or subscriber. In the case of a personal news report being transmitted to a television, the personal news report can be transmitted to the television via, on, or over, a video-on-demand channel associated with, or utilized by, the central processing computer. Any and/or all of the personal news reports can include an advertisement or advertisements.

In any and/or all of the embodiments described herein, a personal news report alert message can be generated and transmitted to the television, personal computer, and/or cellular or wireless communication device, associated with the individual, user, customer, entity, or subscriber, when a personal news report has been generated and is available for viewing. The personal news report alert message can also contain an advertisement or advertisements.

The present invention can also be utilized to allow an advertiser, such as a merchant or vendor of any good, product, or service, or an agent of, or a third party acting on behalf of, the advertiser, to purchase, in an on-line and/or in a real-time environment, an advertisement time slot(s) or advertisement slot(s) in a pre-recorded or live digital television broadcast, program, or show, which is broadcast or transmitted via the present invention. For example, an advertiser, or an agent of, or a third party acting on behalf of, the advertiser, via the advertisement/marketing provider communication device, or via a television, personal computer, or cellular or wireless communication device used by, or associated with, the advertiser, agent, or third party, can access the central processing computer for a given a television station, television network, group of television stations, or group of television networks, and request that information regarding any television programming, program, or show, scheduled to be broadcast or transmitted by the central processing computer and/or by a respective television station or channel be provided to the respective communication device, television, personal computer, or cellular or wireless communication device. The information regarding the programming can be provided, and can include, for each television program or show, the available advertising time slots or advertising slots in the programming wherein an advertisement(s) or commercial(s) can be inserted into the broadcast or transmission to the television, personal computer, or cellular or wireless communication device used by the individual, user, customer, entity, or subscriber.

The information regarding the programming can also include a description of the programming, program, or show, individuals or celebrities appearing in the programming, program, or show, and information regarding the rating or ratings for each respective television program or show and/or for the individuals or celebrities appearing in the programming, program, or show.

The advertiser, agent, or third party, can select and purchase an advertising time slot(s) or advertising slots) in and/or for the respective television program or show. The advertiser, agent, or third party, can also transmit or upload to the central processing computer, or select from the advertisement/marketing computer, an advertisement or commercial containing any one or more of video information, audio information, or text information, which is to be transmitted or uploaded to the central processing computer, for transmission to and storage in the database of the central processing computer. In this manner, an advertiser, agent, or third party, can purchase an advertising time slot(s) or advertising slot(s) and insert the advertisement or commercial to be shown therein. The central processing computer can also process any financial transaction(s) regarding the purchase and/or sale of the advertisement time slot(s) or advertisement slot(s).

In another preferred embodiment, the present invention can also be utilized to create a secondary marketplace for, or a clearinghouse for, advertisement time slots or advertisement slots. In this manner, an advertiser, agent, or third party, can offer for sale or resale an advertising time slot(s) or advertising slot(s) which they have already purchased and hold. The apparatus can be utilized to create an advertising time slot option or an advertising slot option which can be an option or other marketable derivative instrument derived from a respective advertising time slot or advertising slot. An advertiser, agent, or third party, can, for example, sell an advertising option obligating it to sell an advertising time slot or an advertising slot at a pre-determined price for a pre-determined time period. An advertiser, agent, or third party, can also buy an advertising option which will provide it with the right to purchase an advertising time slot or an advertising slot at a pre-determined price for a pre-determined time period.

The apparatus, the central processing computer, the news/information content computer, the ratings computer, and/or the advertisement/marketing computer, can be programmed to automatically find, identify, and/or purchase, advertising time slots or advertising slots in a pre-recorded, or live, digital television broadcast, program, or show, for or on behalf of an advertiser, or agent, or third party acting on behalf of an advertiser. The apparatus, the central processing computer, the news/information content computer, the ratings computer, and/or the advertisement/marketing computer, can be programmed for automatic activation and/or automatic operation. The apparatus and method of the present invention can also utilize intelligent agents, software agents, and/or mobile agents, which can be selected and/or programmed to act on behalf of an advertiser, agent, or third party.

The present invention can also be utilized to gather ratings information. The central processing computer, and/or each central processing computer utilized, can be programmed to gather and process ratings information for or regarding each television program, show, or other content, or for a commercial or advertisement, provided via the apparatus of the present invention. The central processing computer can, for example, transmit periodic interrogation signals to a respective television, or to the cable TV box or to the set-top box associated with the television, to which a program, show, or other content, or to which a commercial or advertisement, is being transmitted via a television or other communication channel so as to ascertain whether or not an individual, user, customer, entity, or subscriber, remains on that channel. The periodic interrogation signals can be transmitted at pre-selected intervals such as, for example, every 30 seconds, every minute, or at any other desired time interval, for a television program, show, or other content. In the case of an advertisement or commercial, the periodic interrogation signals can be transmitted at pre-selected intervals such as, for example, every 5 seconds, every 10 seconds, or at any other desired time interval, to account for the relatively short broadcast times of advertisements or commercials.

The television, or the cable TV box or the set-top box associated with the television, can be programmed to transmit information regarding the channel being viewed back to the central processing computer in response to each interrogation signal. Information regarding a channel being viewed by a television exists in digital form in the television and/or in the cable TV box or the set-top box associated with the television, and this information regarding a channel being viewed is typically displayed either on the screen of the television or on a display of the cable TV box or the set-top box associated with the television.

The television, or the cable TV box or the set-top box associated with the television, can be adapted so that this information, regarding the channel being viewed, can be accessed, monitored, and/or stored, by a circuit or circuits responsible for displaying and/or monitoring same and providing same on the display screen of the television or on the display of the set-top box or cable TV box associated with the television. Upon receiving the periodic interrogation signal, the respective television, or the cable TV box or the set-top box associated with the television, the data and/or information regarding the channel being viewed can be read and stored by the respective television, or the cable TV box or the set-top box associated with the television. The television, or the cable TV box or the set-top box associated with the television, can then generate a reply message containing information regarding the channel being viewed and can transmit the rely message to the central processing computer. The central processing computer can receive and store the information in the reply message and, upon the completion of the respective television program, television show, or other television content, or the advertisement or commercial, can process the information contained in the reply messages, and can determine and assign a ratings number to the respective television program, television show, or other television content, or the advertisement or commercial. The ratings number can be based on ratings numbers or scales typically used in rating television programming and can be based on Nielsen ratings scales and/or any other suitable ratings numbers or scales which are deemed to be appropriate for use in connection with the apparatus and method of the present invention.

The ratings information for the respective television program, television show, or other television content, or the advertisement or commercial, can then be stored in the database of the central processing computer and in the database of the ratings computer.

Each central processing computer utilized in connection with the apparatus of the present invention can gather ratings data and/or information for each television program, television show, television content, or advertisement or commercial, broadcast or transmitted via or by the respective television station, television network, group of television stations, or group of television networks associated with each respective central processing computer. The ratings data and/or information can be stored in real-time or immediately in the database of each respective central processing computer as well as can be stored in real-time, immediately, or periodically, in the database of the ratings computer.

Any and all ratings data and/or information stored in the ratings computer can also be immediately transmitted to, or be made available to, any other central processing computer(s) which are associated with any other television station(s), television network(s), group of television stations, or group of television networks. In this manner, the present invention can provide an apparatus and a method for enabling a television station, a television network, a group of television stations, or a group of television networks, to monitor the ratings of their competitors or affiliates. The ratings information obtained and stored in a respective database of the central processing computer, and/or in the database of the ratings computer, can be automatically provided, such as in a real-time ratings alert message or as an immediate ratings alert message, to the any other central processing computer associated with a competitor or an affiliate. Alternatively, the newly stored ratings data and/or information can be retrieved upon request by a competitor or an affiliate via the central processing computer or other computer or communication device.

In the above described manner, a television station or a television network may self-monitor its programming, programs, shows, or other content, or advertisements or commercials, and self-report data and/or information regarding the ratings of same to competitors, affiliates, advertisers, and/or content providers. By receiving such ratings information, a respective party can, for example, decide to change, alter, or modify, its programming, its programming scheduling, its advertisement strategy, and/or its advertising time slot purchases or advertising slot purchases.

The present invention can also be utilized to monitor and determine ratings of programming, programs, shows, or other content, or advertisement or commercials, which are broadcast to or transmitted to the personal computers and/or to the cellular or wireless communication devices described herein, as well as to any other device(s) described herein as being used by any individual, user, customer, entity, or subscriber, described herein as being able to utilize the present invention.

The present invention can also be utilized to provide real-time, immediate, or periodic, ratings alert messages to any of the individuals or entities described herein.

A ratings provider, which can be or include an organization or entity which performs ratings determinations for television programming, programs, shows, other content, advertisements, and/or commercials, can also, at any time, transmit, enter, and/or update, ratings data and/or information in or at the ratings computer and, in particular, the database in same, via the ratings provider communication device. Ratings data and/or information can also be transmitted, entered, and/or updated, in or at the ratings computer periodically and/or at any time. As noted herein, ratings data and/or information can also be provided by any central processing computer. Any entity or individual which or who utilizes the present invention can request to receive a ratings alert message in real-time, immediately, and/or periodically, whenever a rating of any programming, program, show, other content, advertisement, and/or commercial, is entered into, updated at, and/or stored in, the database of the ratings computer.

Any of the advertisements described herein as being provided in connection with the present invention can be utilized in connection with a link or a hyperlink thereby allowing for a click-through to a merchant's or an advertiser's web site. Any of the advertisements described herein can also be placed in frames surrounding the viewed or viewable programming, program, show, other content, advertisement, or commercial. Lastly, any of the advertisements described herein can also be effectuated via any suitable advertising relationship between a respective advertiser or merchant and a respective television station or television network.

The advertisement relationship between a respective advertiser or merchant and a respective television station or television network can also include an affiliated marketing relationship, wherein the television station or television network can receive compensation, and/or can receive additional compensation over and above any advertising compensation and/or as an alternative to advertising compensation, for transactions regarding the advertised good, product, or service, purchased as a result of, or facilitated by, the advertisement placement.

Any and/or all of the products and/or services described-herein as being provided by the apparatus and method of the present invention can be provided as an advertisement-based product and/or service and/or as a subscription-based products and/or service.

### BRIEF DESCRIPTION OF THE DRAWINGS

### In the Drawings:

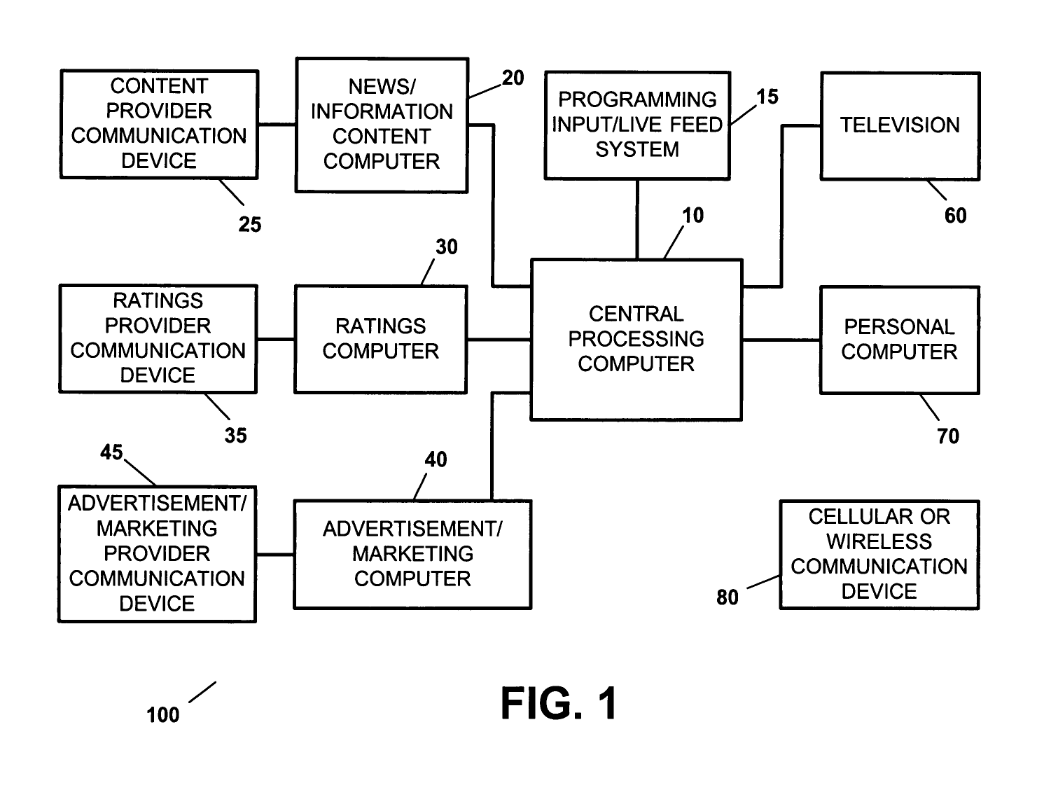

FIG. 1 illustrates the apparatus of the present invention, in block diagram form;

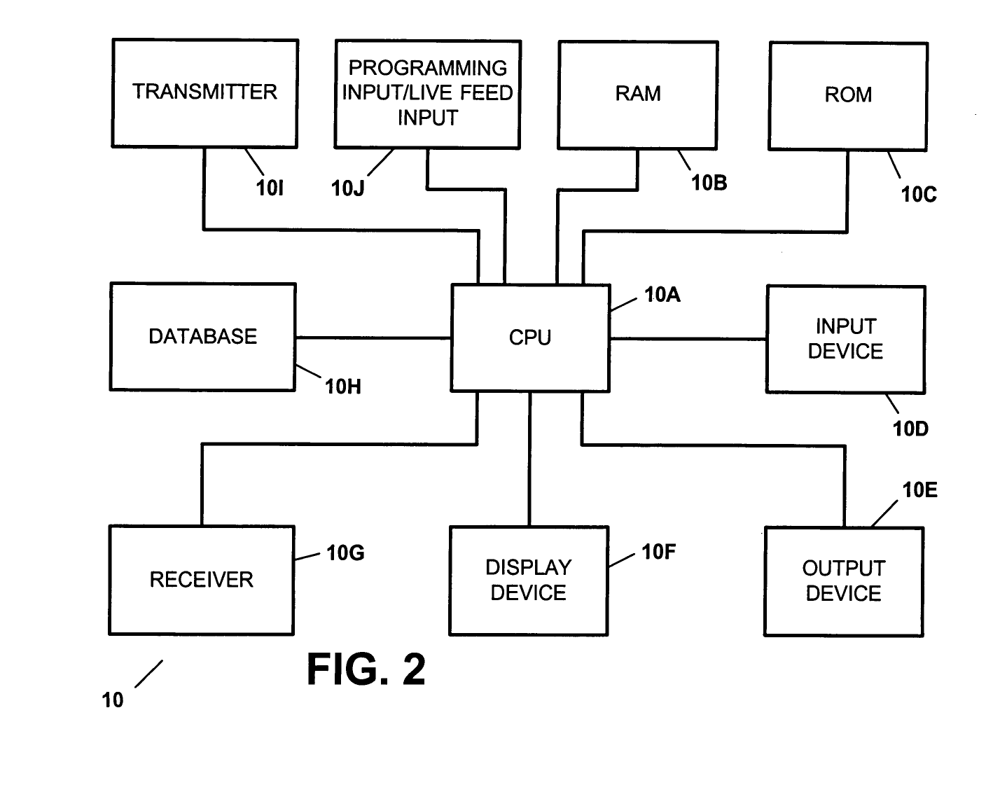

FIG. 2 illustrates the central processing computer of the apparatus of FIG. 1, in block diagram form;

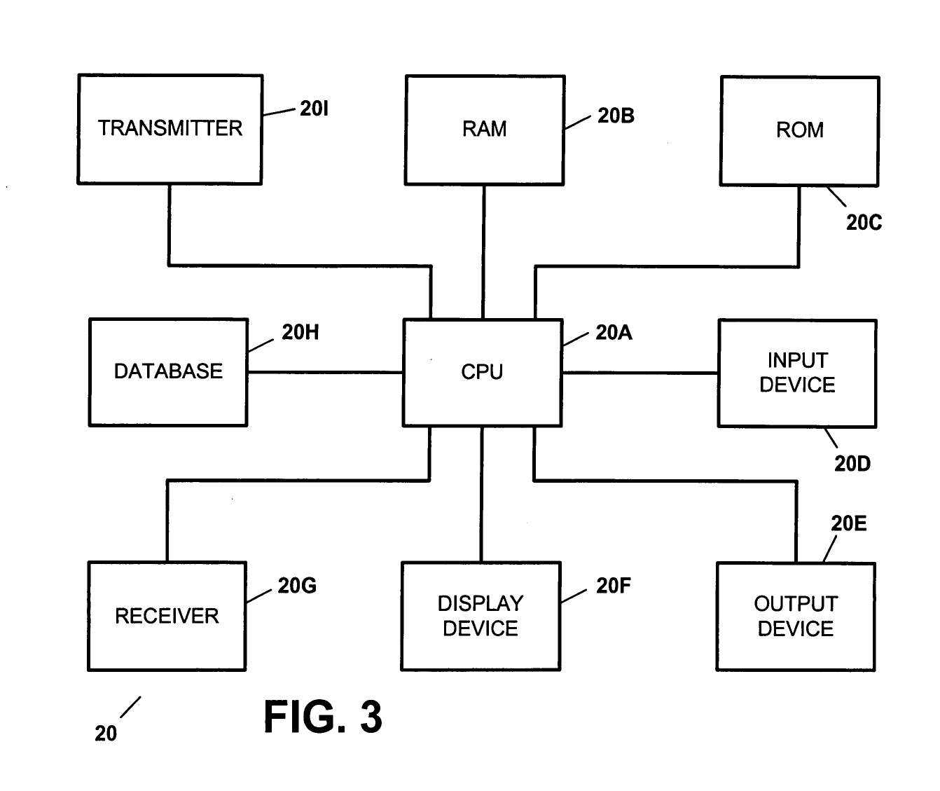

FIG. 3 illustrates the news/information content computer of the apparatus of FIG. 1, in block diagram form;

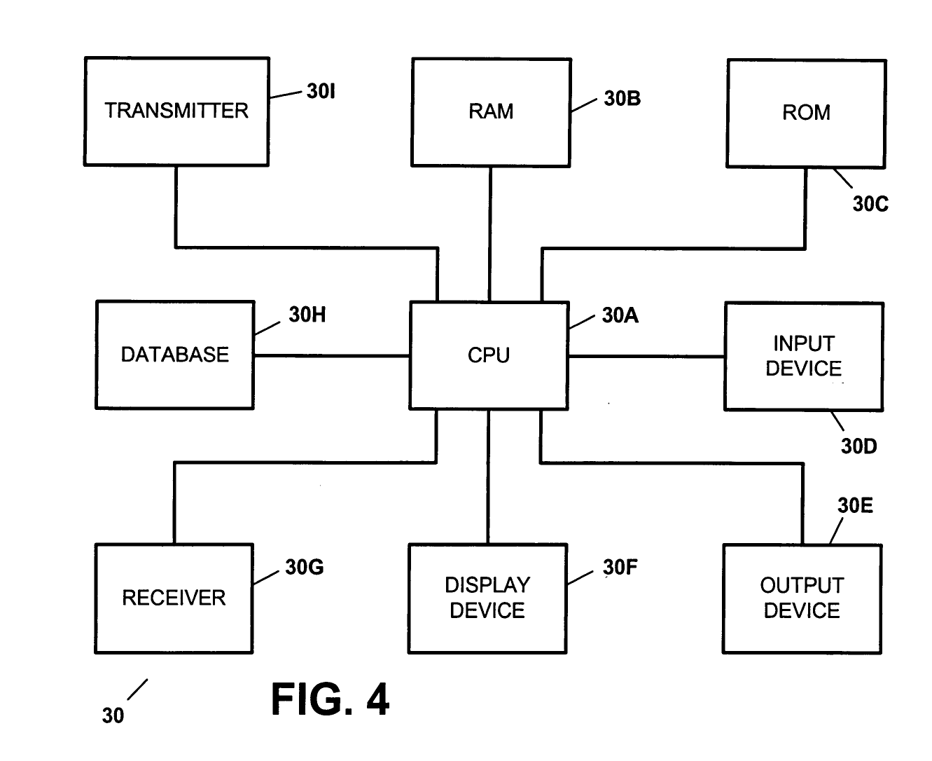

FIG. 4 illustrates the ratings computer of FIG. 1, in block diagram form;

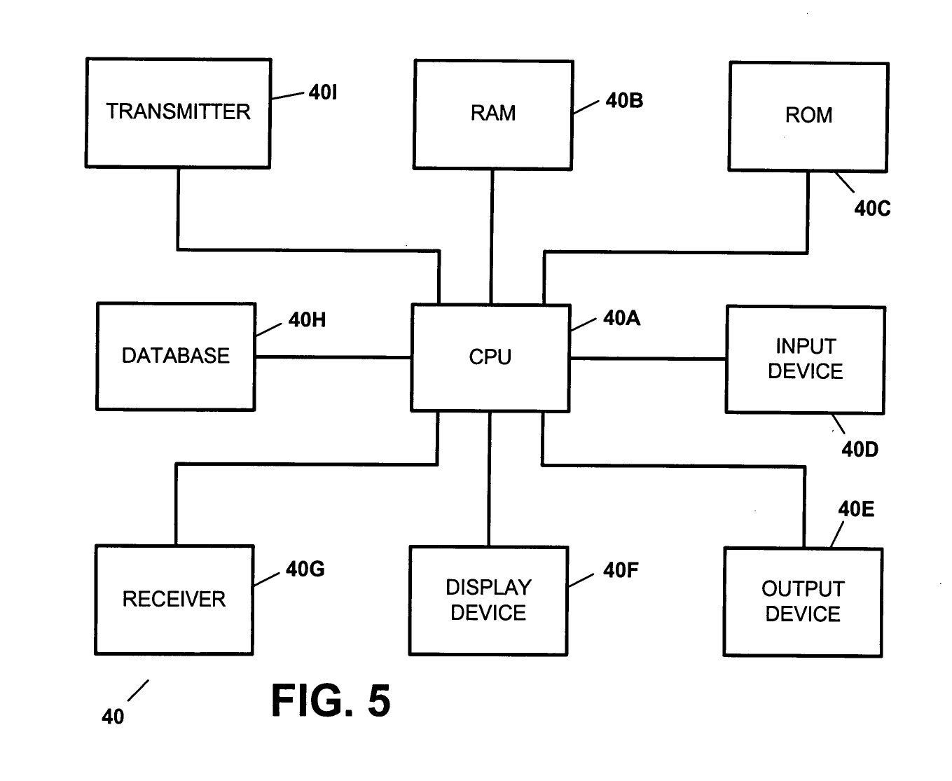

FIG. 5 illustrates the advertisement/marketing computer of FIG. 1, in block diagram form;

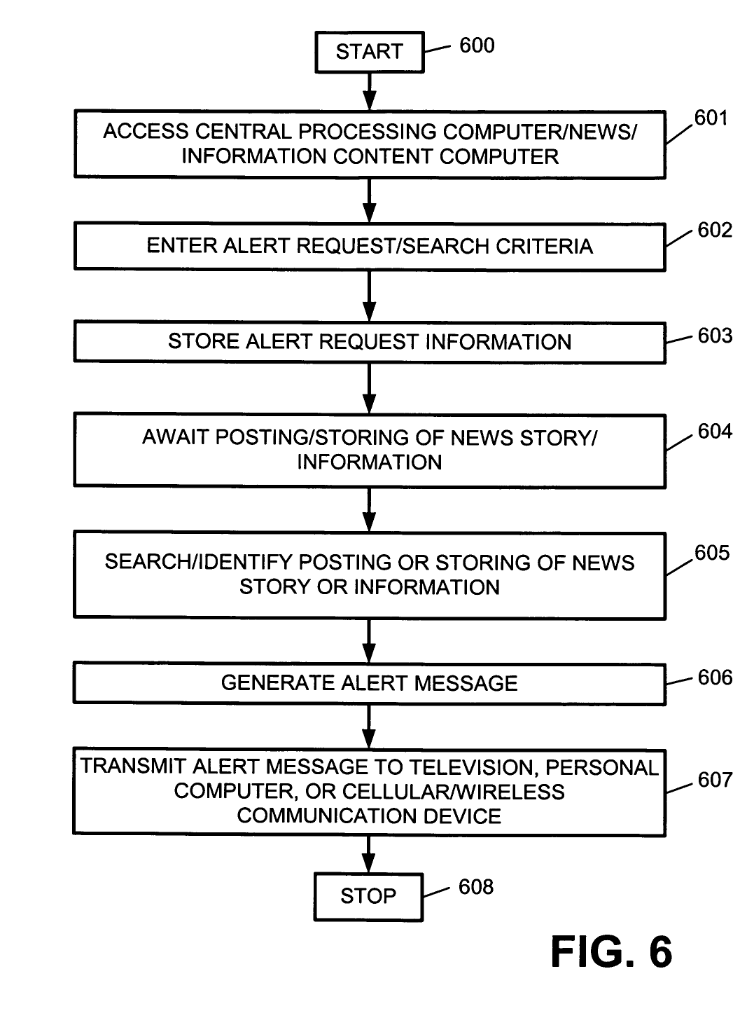

FIG. 6 illustrates a preferred embodiment operation of the apparatus of FIG. 1, in flow diagram form;

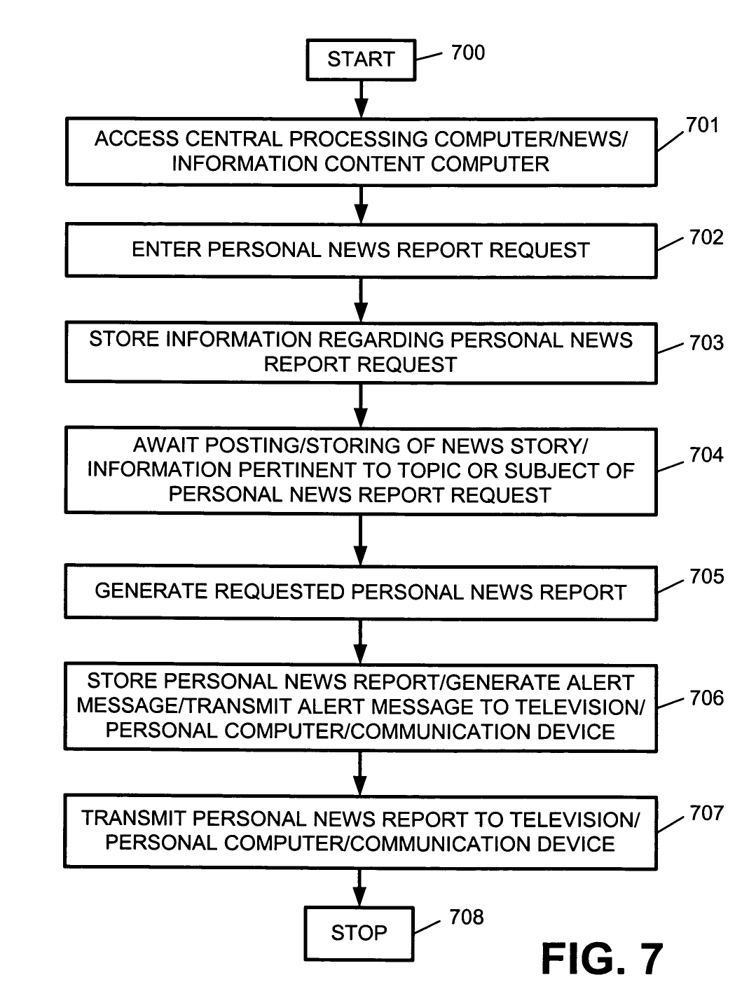

FIG. 7 illustrates another preferred embodiment operation of the apparatus of FIG. 1, in flow diagram form;

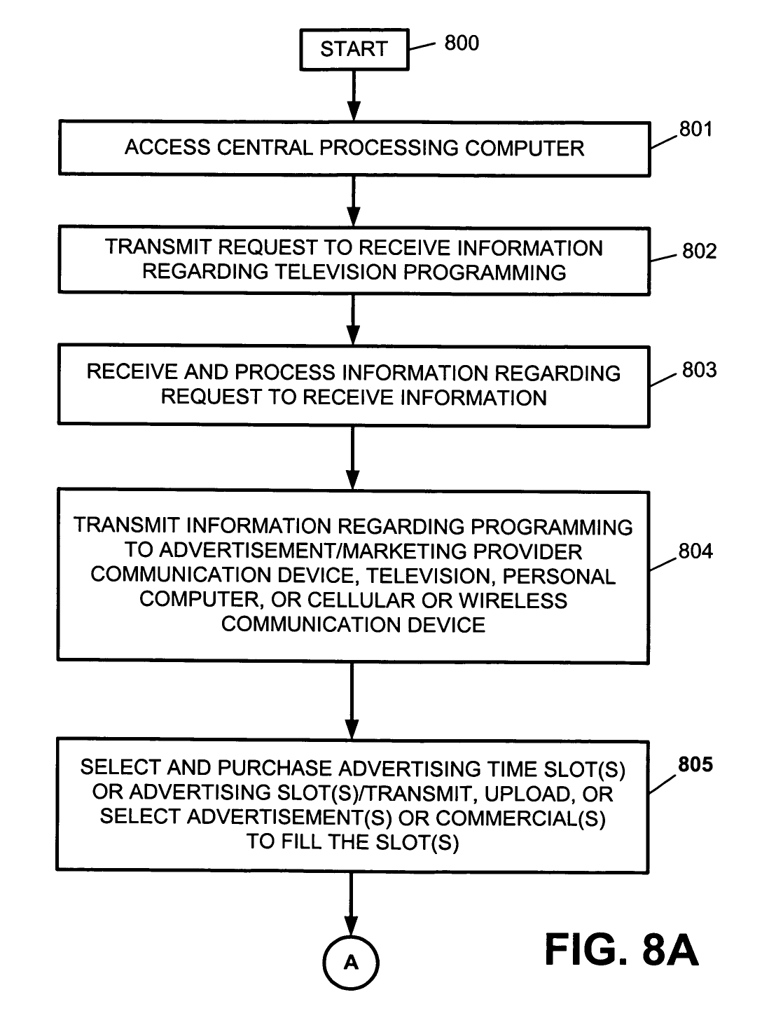

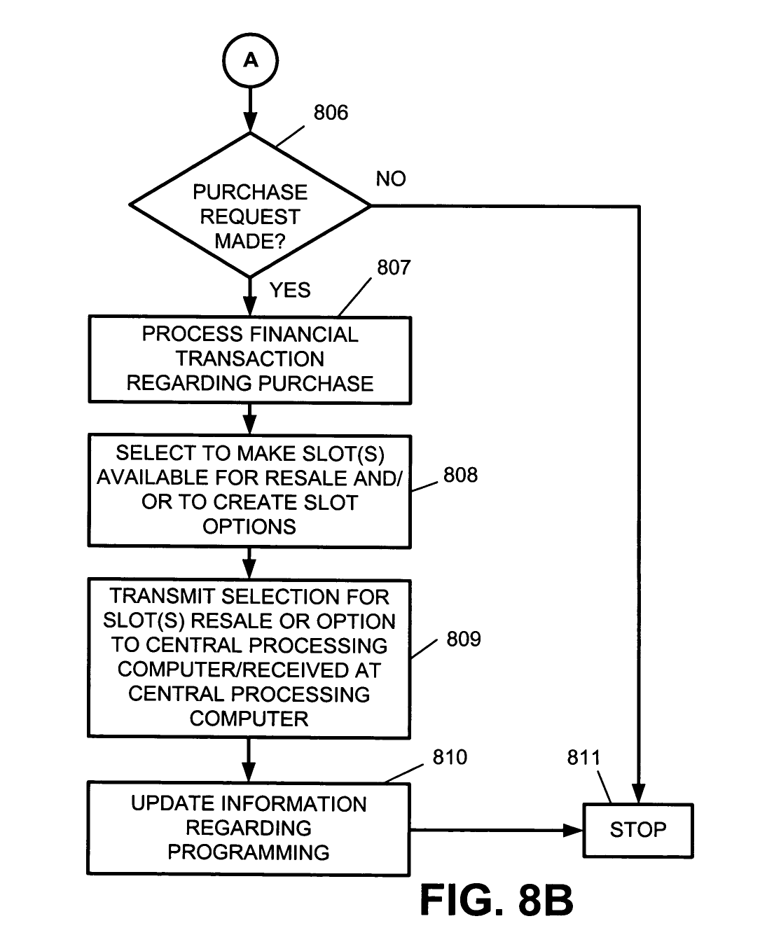

FIGS. 8A and 8B illustrate still another preferred embodiment operation of the apparatus of FIG. 1, in flow diagram form;

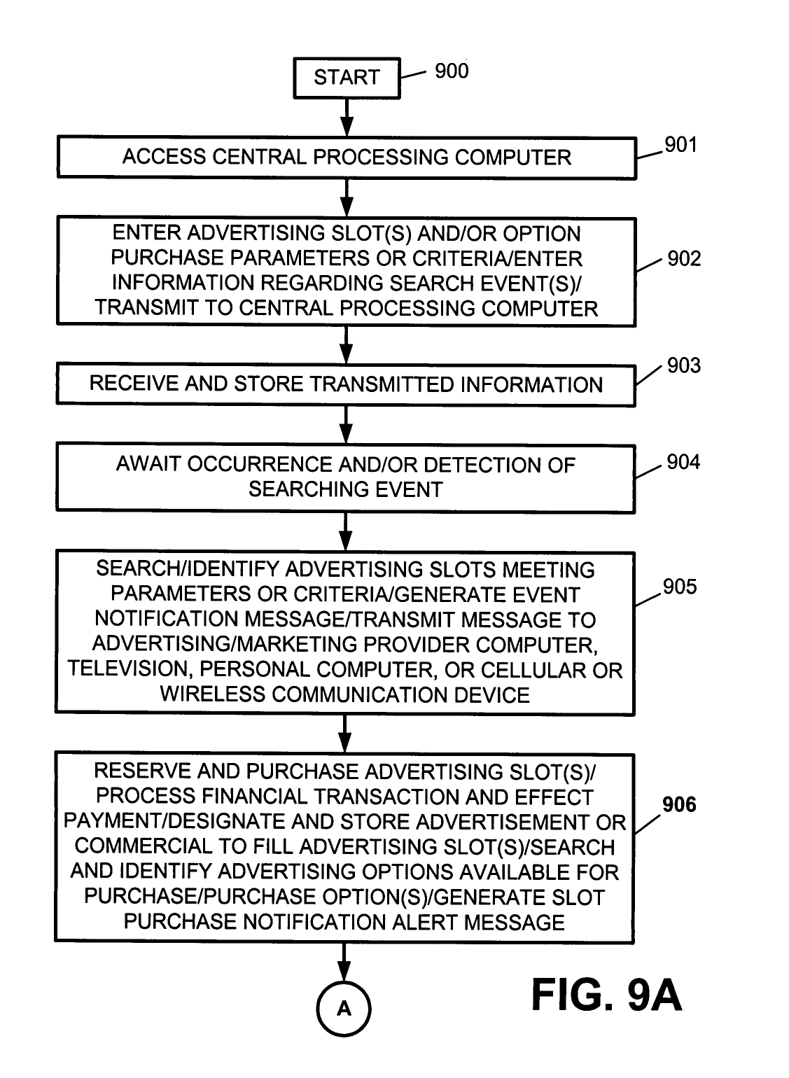

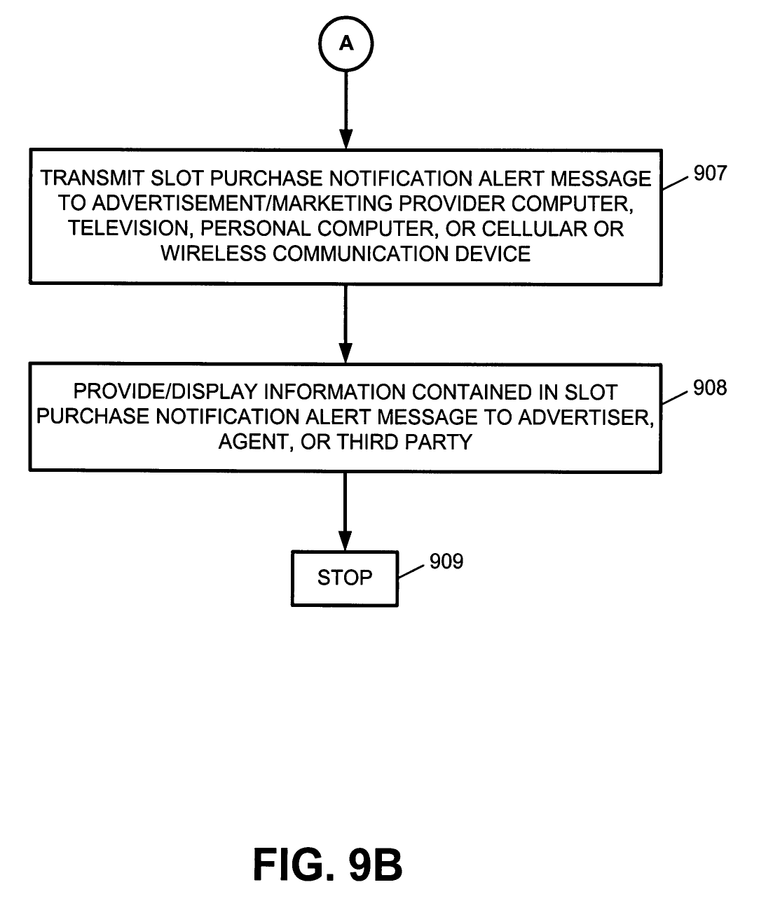

FIGS. 9A and 9B illustrate yet another preferred embodiment operation of the apparatus of FIG. 1, in flow diagram form;

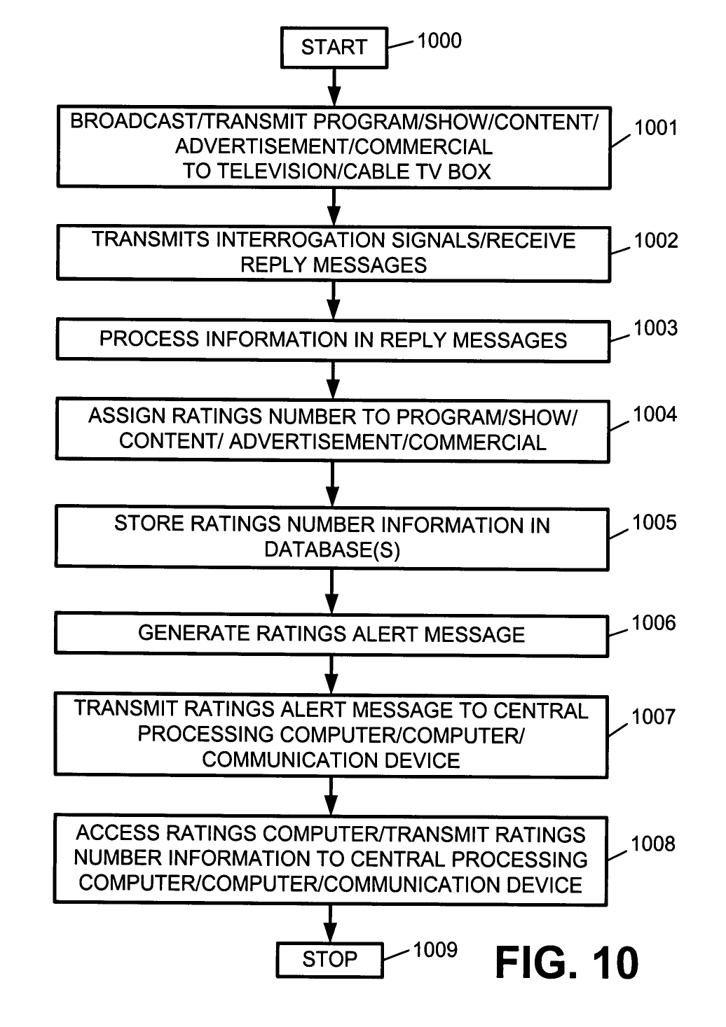

FIG. 10 illustrates another preferred embodiment operation of the apparatus of FIG. 1, in flow diagram form; and

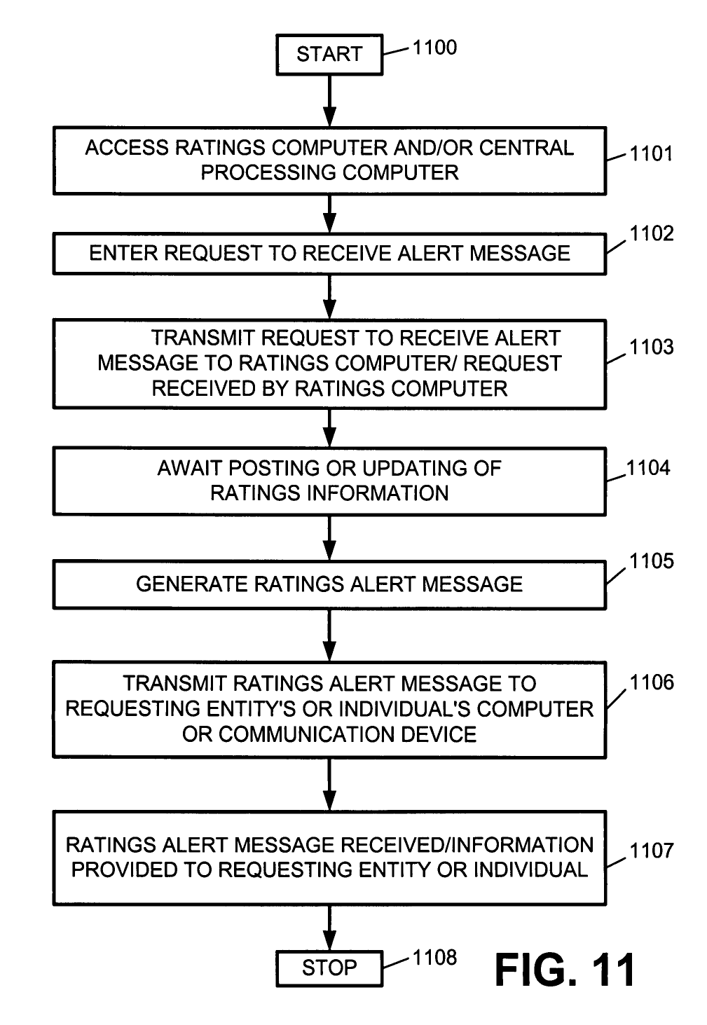

FIG. 11 illustrates yet another preferred embodiment operation of the apparatus of FIG. 1, in flow diagram form.

### DESCRIPTION OF THE PREFERRED EMBODIMENTS

The present invention pertains to a digital television broadcasting apparatus and method for providing information in a digital television and Internet convergent environment and, in particular, the present invention pertains to a digital television broadcasting apparatus and method which provides information in a digital television and Internet convergent environment and which provides enhanced products and/or services for individual consumers, content providers and/or broadcasters, advertisers and/or marketing entities, ratings entities, and others who or which utilize same.

The apparatus and method of the present invention, in a preferred embodiment, provides a system and/or a platform by which content, advertising, marketing materials, and/or ratings information, can be disseminated by or via a digital television broadcasting network, system, or transmission means, by or via the Internet and/or the World Wide Web, and/or by or via a cellular or wireless communications network.

In a preferred embodiment, the apparatus and method of the present invention can be utilized in order to provide a comprehensive news and/or information content database which can store, and/or which can serve as a global, national, regional, and/or local, repository for, news and/or information which can be received from any one or more of any number of content sources or contributing entities or individuals, including, but not limited to, a news service, a news reporting agency, a television station, a radio station, a newspaper, a magazine, a journal, an Internet and/or a World Wide Web content source or provider, a reporter, an author, a research institution or a laboratory, a university, a college, a school and/or any other institution of learning, a journalist, a freelance journalist, and/or an individual or any individual who desires to provide news or information for dissemination via the apparatus and method of the present invention.

In a preferred embodiment, the news and information stored in the comprehensive news and/or information content database can be stored or deposited into the comprehensive news and/or information database by any of the herein-described content sources or contributing entities or individuals via any appropriate computer or communication device and/or via any suitable communication network or system. The deposited news or information can then be purchased for use or dissemination by any appropriate entity or individual with payment being made to the respective content source or contributing entity or individual.

In this manner, the apparatus and method of the present invention can be utilized, in a preferred embodiment, to provide a comprehensive news and/or information database which can provide a vehicle by which news and/or information can be collected in a global, national, regional, or local, manner, and can be made available for use or dissemination by a respective entity or individual anywhere in the World. The comprehensive news and/or information database can also be utilized to sell content and serve as a revenue generation source for the content provider or contributing entity or individual who provides the respective news or information.

In another preferred embodiment, the apparatus and method of the present invention can be utilized to provide for the creation of, and/or for the sale and/or purchase of, content options and/or content derivatives, such as, for example, an option which provides an entity or individual with the right to purchase content stored in the comprehensive news and/or information database at a pre-specified price for a specified time limit, or an option which obligates a content provider to sell content to an entity or individual at a pre-determined price for a pre-determined time period.

In another preferred embodiment, the apparatus and method of the present invention can also be utilized to provide personal news accounts and personal news reports for individuals or entities. In this regard, the apparatus and method of the present invention can provide personal news reports to an individual or entity which can be tailored to the individual's or the entity's specific requests or specified interests. Multiple personal news reports can also be provided to an individual or an entity. For example, an individual may desire to receive a personal news report, which can consist of one or more news stories or information reports, regarding World news, national, regional, or local news, financial, investment, or business, news, health, fitness, or wellness, news, or any other news or information regarding any developments in which the individual or entity is interested or which may be of interest to the individual or entity. A personal news report can be tailored to provide information regarding any area or field of interest of the individual or entity. The personal news report can also contain an advertisement or advertisements.

In another preferred embodiment, the apparatus and method of the present invention can also be utilized to monitor program or information viewership and/or ratings in real-time.

In still another preferred embodiment, the apparatus and method of the present invention can be utilized to provide an advertisement placement functionality whereby advertisement time slots or advertisement slots can be searched, selected, and/or purchased, in an on-line or in an electronic commerce environment. In another preferred embodiment, the apparatus and method of the present invention can also be utilized to provide automated advertisement placement in television broadcast programming and/or in any of the other information or content provided via the apparatus and method of the present invention.

In another preferred embodiment, the apparatus and method of the present invention can also be utilized to process transactions involving the sale and/or purchase of advertising time slots or advertising slots in programming and/or in other information or content provided by the apparatus and method of the present invention, advertising products and/or services, advertisements, advertising, and/or advertisement locations in provided content. The apparatus and method of the present invention can also be utilized to provide a marketplace and/or a clearinghouse for the sale and/or purchase of advertising time slots or advertising slots in programming and/or in other information or content provided via or by the apparatus and method of the present invention, advertising products and/or services, advertisements, advertising, and/or advertisement locations in provided content. The apparatus and method of the present invention can also be utilized in order to create a secondary marketplace and/or on-line marketplace or clearinghouse for the sale and/or purchase of advertising time slots or advertising slots in programming and/or in other information or content provided by the apparatus and method of the present invention, advertising products and/or services, advertisements, advertising, and/or advertisement locations in provided content.

In yet another preferred embodiment, the apparatus and method of the present invention can also be utilized to provide for the creation of, and/or for the sale and/or purchase of, advertising options and/or advertisement derivatives, such as, but not limited to, advertisement options and options for advertising time slots or advertising slots in and/or for programming and/or in and/or for other information or content provided via or by the apparatus and method of the present invention, advertising products and/or services, advertisements, advertising, and/or advertisement locations in provided content.

In still another preferred embodiment, the apparatus and method of the present invention can also be utilized to facilitate affiliated marketing activities in connection with digital television programming and broadcasts.

The apparatus and method of the present invention can also be utilized to provide news alerts and/or to provide alerts regarding the availability of various types of information.

The apparatus and method of the present invention, in another preferred embodiment, can also be utilized to provide immediate and/or real-time alerts to television station operators and other content providers described herein regarding changes in ratings and/or ratings reports.

The apparatus and method of the present invention can also be utilized, in any of the herein-described embodiments, in order to provide advertisement-based products and/or services and/or subscription-based products and/or services.

FIG. 1 illustrates a preferred embodiment of the apparatus of the present invention, which is designated generally by the reference numeral 100, in block diagram form. With reference to FIG. 1, the apparatus 100 includes a central processing computer or server computer 10 (hereinafter “central processing computer 10”). The central processing computer 10 provides control over the apparatus 100 and can perform any and/or all of the various processing operations and/or functionality for providing the various services described herein as being provided by the apparatus 100. The central processing computer 10, in the preferred embodiment, can be any suitable computer, network computer, or computer system, and the central processing computer 10 can be comprised of one or more computers or computer systems. In a preferred embodiment, the central processing computer 10 can be associated with a television station, a television network, a group of television stations, or a group of television networks. The central processing computer 10 can also be associated with a cable television system, a satellite television system, and/or any other system or network which provides television programming, including digital television programming, to the consumer or business markets. In a preferred embodiment, the central processing computer 10 can be associated with a digital television broadcasting network or system, a high definition television (HDTV) broadcasting network or system, a cable television network or system, an Internet Protocol television (IP television) network or system, a satellite or dish television network or system, and/or a conventional television broadcasting system which broadcasts digital television signals.

In a preferred embodiment, any number of central processing computers 10 can be utilized in order to provide the servicing functions described herein as being provided by the apparatus 100 of the present invention. The central processing computer(s) 10 may be linked to other central processing computers or may be stand alone computers or systems.

A given central processing computer 10 may service a particular television market or region, a national television market or region, an international television market or region, and/or the global television market. A central processing computer 10 may also be dedicated to service any one or group of markets. In a preferred embodiment, the central processing computer 10 transmits or broadcasts digital television programming, news, information, advertisements, commercials, marketing information, and/or any other suitable information, in a digital television environment.

With reference once again to FIG. 1, the apparatus 100 also includes a programming input/live fee system 15 which is connected to or linked with the central processing computer 10 and which transmits live programming to the central processing computer 10 for digital television transmission or digital television broadcast to individual devices which can include, but which are not limited to, an individual's television, an individual's personal computer, an individual's cellular or wireless telephone or personal digital assistant, or any other suitable individual device. In a preferred embodiment, the programming input/live fee system 15 can also include a television camera, a video recording device, a video recording device or system, and/or any other devices or systems for recording, and/or for providing, live television or video content. The programming input/live fee system 15 can also be located at any location, at, in, or on, any type of premises, or at, in, or on, any type of vehicle.

With reference once again to FIG. 1, the apparatus 100 also includes a news/information content computer 20 which is connected to or linked with the central processing computer 20. As described herein, the news/information content computer 20 includes a database in which news, news stories, news reports, news programming, news video and/or audio information, articles, research findings, reports, text articles, and/or any other information or content which can be provided via the apparatus 100, is stored. The information or content stored in the database of the news/information content computer 20 can be accessed by and/or can be provided to the central processing computer 10 for transmission or broadcast, or other dissemination, as described herein.

The news, news stories, news reports, news programming, news video and/or audio information, articles, research findings, reports, text articles, and/or any other information or content, stored in the database of the news/information content computer 20 can be transmitted to the news/information content computer 20 from a content provider communication device 25 and/or from any central processing computer 10. The news, news stories, news reports, news programming, news video and/or audio information, articles, research findings, reports, text articles, and/or any other information or content stored in the database of the news/information content computer 20 can also be input into the news/information content computer 20 via any number of input devices. Any number of news/information content computers 20 can be utilized in the apparatus 100.

The apparatus 100 also includes the aforementioned content provider communication device 25 which is connected to or linked with the news/information content computer 20 via any communication network described herein as being utilized in connection with the apparatus 100. The content provider communication device 25 can be used by any news service, news reporting agency, television station, radio station, newspaper, magazine, journal, Internet and/or World Wide Web content source or provider, reporter, author, research institution or laboratory, university, college, school and/or any other institution of learning, journalist, freelance journalist, and/or individual or any individual who desires to provide news or information for dissemination via the apparatus 100 and method of the present invention.

The apparatus 100 also includes a ratings computer 30 which is connected to or linked with the central processing computer 10. The ratings computer 30 includes a database which stores information regarding various ratings and viewership information for various programming, news programs or shows, television programs or shows, informational programs or shows, entertainment programs or shows, sporting and athletic programs or shows, advertisements, commercials, and/or marketing information, which can be provided in a digital television/Internet environment. Ratings information can be transmitted to the ratings computer 30 from the ratings provider communication device 35 and/or from the central processing computer 10 or any central processing computer. Ratings information can also be input into the ratings computer 30 via any number of input devices. Any number of ratings computers 30 can be utilized in the apparatus 100.

The apparatus 100 also includes the aforementioned ratings provider communication device 35 which is connected to or linked with the ratings computer 30 via any communication network described herein as being utilized in connection with the apparatus 100. The ratings provider communication device 35 can be used by any ratings reporting service or organization, television ratings reporting service or organization, radio ratings reporting service or organization, Internet ratings reporting service or organization, a ratings agency, a television station, a television network, a radio station, an Internet service provider, a search engine company, service, or organization, and/or any other entity or individual from which ratings information may be obtained, in order to transmit ratings information to the ratings computer 30.

With reference once again to FIG. 1, the apparatus 100 also includes an advertisement/marketing computer 40 which is connected to or linked with the central processing computer 10. The advertisement/marketing computer 40 includes a database which stores advertisements, commercials, and marketing materials. The advertisements and/or commercials can include commercials can include television, Internet, and/or video and audio, commercials, infomercials, video advertisements, video clips, audio advertisements, audio clips, banner advertisements, button advertisements, advertisements which can be placed on web pages and/or on frames surrounding viewed or viewable content, logos, icons, and/or any other information which can be utilized as an advertisement or commercial. The marketing materials can include surveys, questionnaires, and/or any other materials, which can be utilized in performing marketing research, market research, marketing planning and strategic planning, and/or any other information which can be used for gathering marketing information. The information described herein as being stored in the database of the advertisement/marketing computer 40 can be transmitted to the advertisement/marketing computer 40 from the advertisement/marketing provider communication device 45 which is connected to or linked with the advertisement/marketing computer 40 and/or is transmitted from the central processing computer 10. The information described herein as being stored in the database of the advertisement/marketing computer 40 can also be input into the advertisement/marketing computer 40 via any number of input devices. Any number of advertisement/marketing computers 40 can be utilized in the apparatus 100.

The apparatus 100 also includes the aforementioned advertisement/marketing provider communication device 45 which is connected to or linked with the advertisement/marketing computer 40 via any communication network described herein as being utilized in connection with the apparatus 100. The advertisement/marketing provider communication device 45 can be used by any advertiser, advertising agency, marketing company, marketing research company, and/or by any entity or individual which or who may be desirous of providing advertisements, advertisement information, commercials, infomercials, video advertisements, video clips, audio advertisements, audio clips, banner advertisements, button advertisements, advertisements which can be placed on web pages and/or on frames surrounding viewed or viewable content, logos, icons, and/or any other information which can be utilized as an advertisement, commercial, marketing materials, surveys, questionnaires, and/or any other materials which can be utilized in performing marketing research, market research, marketing planning and strategic planning, and/or any other information which can be used for gathering marketing information.

With reference once again to FIG. 1, the apparatus 100 also includes a television 60 which, in the preferred embodiment, is associated with any herein-described individual, user, customer, entity, or subscriber, of a television station, television network, group of television stations, group of television networks, cable television provider, or satellite or dish television provider, associated with the central processing computer 10. In the preferred embodiment, the television 60 is a digital television, a high definition television, and/or an interactive television. The television 60 may have associated therewith a so-call “cable TV box” or “set-top box” and/or a remote control device which allows an individual, user, customer, entity, or subscriber, to interact with the television 60, with central processing computer 10, and with the respective television station, television network, group of television stations, group of television networks, cable television provider, or satellite or dish television provider, associated with the central processing computer 10.

A television 60, in addition to being associated with or used by an individual, user, customer, entity, or subscriber, of the respective television station, television network, group of television stations, group of television networks, cable television provider, or satellite or dish television provider, associated with the central processing computer 10, can also be associated with or used by a respective television station, television network, group of television stations, group of television networks, cable television provider, or satellite or dish television provider, associated with the central processing computer 10, a provider of news content, a provider of ratings information, and/or a provider of advertisement, commercials, or marketing information.

The television 60 can send signals, data, and/or information, to, and/or can receive signals, data, and/or information, from, any one or more of the central processing computer 10, the news/information content computer 20, the content provider communication device 25, the ratings computer 30, the ratings provider communication device 35, the advertisement/marketing computer 40, and/or the advertisement/marketing provider communication device 45.

With reference once again to FIG. 1, the apparatus 100 also includes a personal computer or personal communication device 70 which, in the preferred embodiment, is associated with any herein-described individual, user, customer, entity, or subscriber, of a television station, television network, group of television stations, group of television networks, cable television provider, or satellite or dish television provider, associated with the central processing computer 10. In the preferred embodiment, the personal computer or personal communication device 70 can also be, or can include, a home computer, a laptop computer, a handheld computer, a personal communication device, a personal communication services device, a personal digital assistant, a “smart” telephone, and/or a watch. The personal computer or personal communication device 70 can be used to allow an individual, user, customer, entity, or subscriber, to interact with the central processing computer 10 and/or with the respective television station, television network, group of television stations, group of television networks, cable television provider, or satellite or dish television provider, associated with the central processing computer 10.

A personal computer or personal communication device 70, in addition to being associated with or used by an individual, user, customer, entity, or subscriber, of the respective television station, television network, group of television stations, group of television networks, cable television provider, or satellite or dish television provider, associated with the central processing computer 10, can also be associated with a respective television station, television network, group of television stations, group of television networks, cable television provider, or satellite or dish television provider, associated with the central processing computer 10, a provider of news content, a provider of ratings information, and/or a provider of advertisements, commercials, or marketing information.

The personal computer or personal communication device 70 can send signals, data, and/or information, to, and/or can receive signals, data, and/or information, from, any one or more of the central processing computer 10, the news/information content computer 20, the content provider communication device 25, the ratings computer 30, the ratings provider communication device 35, the advertisement/marketing computer 40, and/or the provider communication device 45.

With reference once again to FIG. 1, the apparatus 100 also includes a cellular or wireless communication device 80 which, in the preferred embodiment, is associated with any herein-described individual, user, customer, entity, or subscriber, of a television station, television network, group of television stations, group of television networks, cable television provider, or satellite or dish television provider, associated with the central processing computer 10. In the preferred embodiment, the cellular or wireless communication device 80 can also be, or can include, a cellular telephone, a wireless telephone, a mobile telephone, a video telephone, a videophone, a personal digital assistant, a personal communication device, a personal communication services device, and/or a watch. The cellular or wireless communication device 80 can be used to allow an individual, user, customer, entity, or subscriber, to interact with the central processing computer 10 and/or with the respective television station, television network, group of television stations, group of television networks, cable television provider, or satellite or dish television provider, associated with the central processing computer 10.

A cellular or wireless communication device 80, in addition to being associated with or used by an individual, user, customer, entity, or subscriber, of the respective television station, television network, group of television stations, group of television networks, cable television provider, or satellite or dish television provider, associated with the central processing computer 10, can also be associated with a respective television station, television network, group of television stations, group of television networks, cable television provider, or satellite or dish television provider, associated with the central processing computer 10, a provider of news content, a provider of ratings information, and/or a provider of advertisements or marketing information.

The cellular or wireless communication device 80 can send signals, data, and/or information, to, and/or can receive signals, data, and/or information, from, any one or more of the central processing computer 10, the news/information content computer 20, the content provider communication device 25, the ratings computer 30, the ratings provider communication device 35, the advertisement/marketing computer 40, and/or the provider communication device 45.

The communications network(s) and/or system(s) via, on, or over, which the apparatus 100 of the present invention can be utilized, and via, on, or over, which any of the herein-described devices 10, 15, 20, 25, 30, 35, 40, 45, 60, 70, and/or 80 may communicate with each other, can include any one or combination of a telecommunication network(s) or system(s), a satellite communication network(s) or system(s), a radio communication network(s) or system(s), a digital communication network(s) or system(s), a digital satellite communication network(s) or system(s), a personal communications services network(s) or system(s), a cable television network(s) or system(s), satellite or dish television network(s) or system(s), a digital television network(s) or system(s), a broadband communication network(s) or system(s), a low earth orbiting satellite (LEOs) network(s) or system(s), the Internet and/or the World Wide Web, a cellular communication network(s) or system(s), a wireless communication network(s) or system(s), and/or on or over any suitable internet(s) and/or intranet(s).

FIG. 2 illustrates the central processing computer 10 of FIG. 1, in block diagram form. The central processing computer 10, in the preferred embodiment, is a network computer or computer system and can consist of, or can include, a single computer or computer system or a plurality of computers or computer systems. As noted herein, the central processing computer 10 can be associated with a television station, a television network, a group of television stations, or a group of television networks. The central processing computer 10 can also be associated with a cable television system, a satellite television system, and/or any other system or network which provides digital television programming to the consumer or business markets. In a preferred embodiment, the central processing computer 10 can be, or can be associated with, a digital television broadcasting network or system, a high definition television (HDTV) broadcasting network or system, a cable television network or system, an Internet Protocol television (IP television) network or system, a satellite or dish television network or system, and/or a conventional television broadcasting network or system which broadcasts digital television signals. The central computer system 10 can also be, or can be a component o, a digital television broadcasting network or system.

With reference to FIG. 2, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) (RAM) 10B and a read only memory device(s) (ROM) 10C, each of which is connected to the CPU 10A, a user input device 10D which is connected to the CPU 10A, for entering data and/or commands into the central processing computer 10, and which can include any one or more of a keyboard, a scanner, a user pointing device, such as, for example, a mouse, a touch pad, and/or an audio input device and/or a video input device, etc., if desired. The input device(s) is also connected to the CPU 10A. The central processing computer 10 also includes an output device 10E such as a printer, a modem, a fax/modem, or other output device, which is connected to the CPU 10A, and which provides data and/or information to the operator or user of the central processing computer 10 or to a third party or third party entity. The central processing computer 10 also includes a display device 10F, which is connected to the CPU 10A, which displays data and/or information to a user or operator.

The central processing computer 10 also includes a receiver 10G, which is also connected to the CPU 10A, and which can include one receiver or any number of receivers, for receiving signals and/or data and/or information from any one or more of any other central processing computer(s) 10, the programming input/live feed system 15, the news/information content computer 20, the content provider communication device 25, the ratings computer 30, the ratings provider communication device 35, the advertisement/marketing computer 40, the advertisement/marketing provider communication device 45, the television 60 or any number of televisions 60 serviced by the central processing computer 10, the personal computer 70 or any number of personal computers 70 serviced by the central processing computer 10, and/or the cellular or wireless communication device 80 or any number of cellular or wireless communication devices 80 serviced by the central processing computer 10.

The central processing computer 10 also includes a database 10H which can store any and/or all data and/or information needed or required for performing any and/or all of the operations and functions described herein as being performed by or provided by the apparatus 100 and method the present invention. In the preferred embodiment, any and/or all data and/or information described herein as being stored in the news/information content computer 20 and/or the respective database in or associated therewith, the ratings computer 30 and/or the respective database in or associated therewith, and the advertisement/marketing computer 40 and/or the respective database in or associated therewith, can be stored in the database 10H along with any of the other data and/or information described herein as being utilized by the apparatus 100 in performing any and/or all of the operations and functions described as being performed or provided by the apparatus 100 and method of the present invention.

The database 10H can contain or include data and/or information regarding each television station, each television network, each group of television stations, each group of television networks, each cable television system, each satellite television system, and/or any other system or network for which the central processing computer 10 is associated or for which the use of the central processing computer is dedicated, along with containing data and/or information regarding each television channel serviced by the central processing computer 10, the respective programming and scheduling for each television channel, and/or the respective advertisement time slot schedules or advertisement slot schedules for each television channel.

The database 10H can also contain or include data and/or information regarding the individuals, users, customers, entities, or subscribers, serviced by the central processing computer 10, which can include, but not be limited to, the individuals, users, customers, entities, or subscribers who are the consumers of the television programming and/or other information or content services provided by the apparatus 100 and method of the present invention (hereinafter referred to as the “individual viewer” or “individual viewers”), and/or the programming providers, news providers, information providers, ratings and/or ratings information providers, advertisers, marketers, and/or providers of advertisements, commercials, and/or marketing information, who or which utilize, or are serviced by, the apparatus 100 of the present invention.

The database 10H can also contain or include data and/or information regarding personal or individual news accounts, or personal or individual information accounts, which can be used to provide personal news or information report(s) (hereinafter “personal news reports”) to a respective individual viewer, and/or to a respective programming provider, news provider, information provider, ratings and/or ratings information provider, advertiser, marketer, and/or provider of advertisements, commercials, and/or marketing information, on request and/or automatically. The personal news report(s) can include one or more news stories or information segments deemed to be of interest to the respective individual viewer, or to the respective programming provider, news provider, information provider, ratings and/or ratings information provider, advertiser, marketer, and/or provider of advertisements, commercials, and/or marketing information.

The database 10H can also contain or include data and/or information for providing news or information alerts to a respective individual viewer, and/or to a respective programming provider, news provider, information provider, ratings and/or ratings information provider, advertiser, marketer, and/or provider of advertisements, commercials, and/or marketing information, who or which can request to be automatically notified, in real-time, immediately, and/or otherwise, regarding the occurrence of an event and/or the receipt and/or storing of a news story or other information by the apparatus 100, and/or by any of the respective databases 10H, 20H, 30H, and/or 40H.

The database 10H also contains data and/or information regarding any news, news stories, news reports, news programming, news video and/or audio information, articles, research findings, reports, text articles, and/or any other information, and/or files including digital or electronic versions of same, which can be provided via the apparatus 100 and method of the present invention.

The database 10H, for example, can contain or include data and/or information regarding World news or information, U.S. news or information, national news or information for each country covered, international news or information, regional news or information, local news or information, news or information regarding politics, business, finance, investing, health and healthcare, technology, law, medicine, dentistry, crime, entertainment, travel, living and/or human interest, sports, consumer information, weather, traffic, education, and/or any other subject or topic for which news or information may be reported.

The database 10H can also include data and/or information for providing any of the news or information stored in the database 10H via a digital television, via a personal computer or other personal computing device, or via a cellular or wireless telephone, personal digital assistant, or other wireless or mobile device.

The database 10H can also contain or include data and/or information regarding the television ratings for all programming, television programs or shows, television news programs or shows, television news magazines and documentaries, sports and/or sporting programs or shows, cultural and/or artistic programs or shows, and/or any other type of programs, shows, or programming (hereinafter referred to as “programming”), advertisements and/or commercials, marketing information, and/or any other programs, shows, broadcasts, etc., provided via each television station, television network, group of television stations, or group of television networks, serviced by the apparatus 100 and method of the present invention. The information regarding the television ratings can include, for example, Nielsen ratings information and other ratings information provided by third party sources, which can be submitted via a respective ratings provider communication device 35, and/or the information regarding the television ratings can be provided by the respective television station, television network, group of television stations, or group of television networks, serviced by the apparatus 100 and method of the present invention, and/or via a respective central processing computer 10.

The information regarding television ratings can include any conventional ratings information as well as ratings obtained from polling or interrogating each individual's, user's, customer's, entity's, or subscriber's, television 60, personal computer 70, and/or cellular or wireless communication device 80 via the central processing computer 10, in a periodic manner.

For example, in a preferred embodiment, the central processing computer 10 can transmit a polling signal or an interrogation signal to an individual's, user's, customer's, entity's, or subscriber's, television 60, personal computer 70, and/or cellular or wireless communication device 80 during programming. This polling signal or interrogation signal can be transmitted to the individual's, user's, customer's, entity's, or subscriber's, television 60, personal computer 70, and/or cellular or wireless communication device 80 every minute, every 30 seconds, or at any other desired time interval during a program or show so as to poll or monitor the individual's, user's, customer's, entity's, or subscriber's, behavior during the program or show. The individual's, user's, customer's, entity's, or subscriber's, television 60, personal computer 70, and/or cellular or wireless communication device 80 can transmit a reply signal back to the central processing computer 10 in response to each polling signal or interrogation signal.

The reply signal(s) can contain information regarding the television channel or program or show being shown on the individual's, user's, customer's, entity's, or subscriber's, television 60, personal computer 70, and/or cellular or wireless communication device 80 at that point in time. The information received can then be compiled so as to provide real-time polling or monitoring of the behavior of the individual, user, customer, entity, or subscriber, and/or for determining real-time rating information regarding the respective program or show.

The database 10H can also include ratings regarding advertisements and commercials, as well as ratings information regarding any marketing information transmitted to or broadcast to an individual's, user's, customer's, entity's, or subscriber's, television 60, personal computer 70, and/or cellular or wireless communication device 80.

The database 10H can also contain or include data and/or information regarding any of the herein-described ratings information for any and all of the television programming, programs, and/or shows, broadcast by the television stations and television networks serviced by the apparatus 100, as well as ratings information for the television stations and networks. The database 10H can also contain data and/or information comparing the ratings information for each of the television programming, programs, and/or shows, broadcast by the television stations and television networks, as well as information comparing ratings information for the television stations and television networks. The information stored in the database 10H can be accessed by any television station or television network which utilizes the apparatus 100 and method of the present invention.

The database 10H can also include any other ratings data and/or information needed and/or desired for performing any and/or all of the operations and functions described herein as being performed or provided by the apparatus 100 of the present invention.

The database 10H can include advertisements and/or commercials, including television, Internet, and/or video and audio, commercials, infomercials, video advertisements, video clips, audio advertisements, audio clips, banner advertisements, button advertisements, text advertisements, graphical, banner and/or button, advertisements, audio-visual advertisements, interactive advertisements of any of the above-described variety, dynamic advertisements, static advertisements, advertisements which can be placed on web pages and/or on frames surrounding viewed or viewable content, logos, icons, and/or any other information which can be utilized as an advertisement or commercial, as well as any data, information, and/or files, etc., regarding same. The advertisements or commercials can be for or corresponding to any good, goods, product, products, service, and/or services.

The database 10H can also contain or include the prices for advertisement time slots or advertisement slots which are offered by, or charged by, each television station, television network, group of television stations, or group of television networks, which are serviced by the apparatus 100 and method of the present invention to run or place an advertisement or commercial.

The database 10H can also contain or include information regarding the prices which advertisers are willing to pay to place their respective advertisements or commercials. The database 10H can also contain data and/or information regarding success rates for the various advertisements or commercials stored in the database 10H.

The database 10H can also include information regarding affiliated marketing relationships which can be entered into between an advertiser(s) and a television station(s), television network(s), group of television stations, or group of television networks, as well as information for establishing and servicing these affiliated marketing relationships.

The database 10H can also include marketing materials which can include, but not be limited to, surveys, polls, polling information, and/or questionnaires, such as text surveys, polls, polling information, and/or questionnaires, video surveys, polls, polling information, and/or questionnaires, audio surveys, polls, polling information, and/or questionnaires, graphical, banner and/or button, surveys, polls, polling information, and/or questionnaires, audio-visual surveys, polls, polling information, and/or questionnaires, interactive surveys, polls, polling information, and/or questionnaires, of any of the above-described variety, dynamic surveys, polls, polling information, and/or questionnaires, static surveys, polls, polling information, and/or questionnaires, along with the amounts of compensation, the reward, the rebate, and/or the incentive, for viewing, and/or for participating in, the respective surveys, polls, polling information, and/or questionnaires. The database 10H can also contain any data and/or information for or regarding calculating a respective compensation, reward, rebate, and/or incentive, for any individual, user, customer, entity, or subscriber, who has viewed and/or participated in a survey, poll, and/or questionnaire.

The database 10H can also contain any other materials or information which can be utilized in performing marketing research, market research, marketing planning and strategic planning, and/or any other information which can be used for gathering marketing information. The database 10H can also contain data and/or information regarding the preferences of any individuals, users, customers, entities, or subscribers, of the apparatus 100 to receive and/or to participate in certain surveys, polls, and/or questionnaires, data and/or information correlating surveys, polls, polling information, and/or questionnaires, with the purchase or sale of certain goods, products, and/or services, and/or any other data and/or information needed and/or desired for facilitating the operation of the apparatus and method of the present invention as described herein.

The database 10H can also contain data and/information regarding advertising time slots or advertising slots in programming provided via the apparatus 100 and method of the present invention.

The database 10H can also contain data and/or information for providing options for buying advertisement slots in programming and/or for selling options for advertisement slots in programming.

The database 10H can also contain data and/or information for providing options for buying content.

The database 10H can also contain data and/or information for selling advertisement time slots or advertising slots in programming as well as for providing a secondary marketplace for selling or purchasing advertisement time slots or advertising slots.

The database 10H can also include any other advertisement, commercial, and/or marketing information needed and/or desired for performing any and/or all of the operations and functions described herein as being performed or provided by the apparatus 100 and method of the present invention.

The database 10H can also contain or include any of the herein-described data and/or information described herein as being input into the central processing computer 10 or the apparatus 100 or any of its component computers or devices, as being processed by the central processing computer 10 or the apparatus 100 or any of its component computers or devices, and/or as being generated by the central processing computer 10 or the apparatus 100 or any of its component computers or devices.

The central processing computer 10 also includes a transmitter(s) 10I, which is connected to the CPU 10A, and which can include one transmitter or any number of transmitters, for transmitting signals and/or data and/or information to any one or more of any other central processing computer(s) 10, the programming input/live feed system 15, the news/information content computer 20, the content provider communication device 25, the ratings computer 30, the ratings provider communication device 35, the advertisement/marketing computer 40, the advertisement/marketing provider communication device 45, the television 60 or any number of televisions 60 serviced by the central processing computer 10, the personal computer 70 or any number of personal computers 70 serviced by the central processing computer 10, and/or the cellular or wireless communication device 80 or any number of cellular or wireless communication devices 80 serviced by the central processing computer 10.

With reference once again to FIG. 2, the central processing computer 10 also includes a programming input/live feed input device 10J, which is connected to the CPU 10A, and which receives live programming transmitted from or provided from the programming input/live fee system 15.

FIG. 3 illustrates the news/information content computer 20 of FIG. 1, in block diagram form. The news/information content computer 20, in the preferred embodiment, is a network computer or computer system and can consist of, or can include, a single computer or computer system or a plurality of computers or computer systems. The news/information content computer 20 can be a centralized content database computer or computer system for storing content for global access. The news/information content computer 20 can also be associated with a television station, a television network, a group of television stations, a group of television networks, a cable television system, a satellite television system, and/or any other system or network which provides television programming to the consumer or business markets.

With reference to FIG. 3, the news/information content computer 20 includes a central processing unit or CPU 20A, which in the preferred embodiment, is a microprocessor. The CPU 20A may also be a microcomputer, a minicomputer, a macro-computer, and/or a mainframe computer, depending upon the application.

The news/information content computer 20 also includes a random access memory device(s) (RAM) 20B and a read only memory device(s) (ROM) 20C, each of which is connected to the CPU 20A, a user input device 20D which is connected to the CPU 20A, for entering data and/or commands into the news/information content computer 20, and which can include any one or more of a keyboard, a scanner, a user pointing device, such as, for example, a mouse, a touch pad, and/or an audio input device and/or a video input device, etc., if desired. The input device(s) is also connected to the CPU 20A. The news/information content computer 20 also includes an output device 20E such as a printer, a modem, a fax/modem, or other output device, which is connected to the CPU 20A, and which provides data and/or information to the operator or user of the news/information content computer 20 or to a third party or third party entity. The news/information content computer 20 also includes a display device 20F, which is connected to the CPU 20A, which displays data and/or information to a user or operator.

The news/information content computer 20 also includes a receiver 20G, which is also connected to the CPU 20A, and which can include one receiver or any number of receivers, for receiving signals and/or data and/or information from any one or more of the central processing computer(s) 10, the programming input/live feed system 15, any other news/information content computer(s) 20, the provider communication device(s) 25, the ratings computer 30, the ratings provider communication device 35, the advertisement/marketing computer 40, the advertisement/marketing provider communication device 45, the television 60 or any number of televisions 60 serviced by the apparatus 100, the personal computer 70 or any number of personal computers 70 serviced by the apparatus 100, and/or the cellular or wireless communication device 80 or any number of cellular or wireless communication devices 80 serviced by the apparatus 100.

The news/information content computer 20 also includes a database 20H which can store any and/or all data and/or information needed or required for performing any and/or all of the operations and functions described herein as being performed by, or provided by, the apparatus 100 and method the present invention and/or by the news/information content computer 20.

The database 20H contains data and/or information regarding any news, news stories, news reports, news programming, news video and/or audio information, articles, research findings, reports, text articles, and/or any other information or content, and/or files including digital or electronic versions of same, which can be provided via the apparatus 100 and method of the present invention.

The database 20H, for example, can contain or include data and/or information regarding World news or information, U.S. news or information, national news or information for each country covered, international news or information, regional news or information, local news or information, news or information regarding politics, business, finance, investing, health and healthcare, technology, law, medicine, dentistry, crime, entertainment, travel, living and/or human interest, sports, consumer information, weather, traffic, education, and/or any other subject or topic for which news or information my be reported.

The database 20H can also include data and/or information for providing any of the news or information stored in the database 20H via a digital television, via a personal computer or other personal computing device, or via a cellular or wireless telephone, personal digital assistant, or other wireless or mobile device.

The database 20H can also contain or include any of the data and/or information described herein as being input into the news/information content computer 20 or the apparatus 100 or any of its component computers or devices, as being processed by the news/information content computer 20 or the apparatus 100 or any of its component computers or devices, and/or as being generated by the news/information content computer 20 or the apparatus 100 or any of its component computers or devices.

The news/information content computer 20 also includes a transmitter(s) 20I, which is connected to the CPU 20A, and which can include one transmitter or any number of transmitters, for transmitting signals and/or data and/or information to any one or more of the central processing computer(s) 10, the programming input/live feed system 15, any other news/information content computer(s) 20, the provider communication device(s) 25, the ratings computer 30, the ratings provider communication device 35, the advertisement/marketing computer 40, the advertisement/marketing provider communication device 45, the television 60 or any number of televisions 60 serviced by the apparatus 100, the personal computer 70 or any number of personal computers 70 serviced by the apparatus 100, and/or the cellular or wireless communication device 80 or any number of cellular or wireless communication devices 80 serviced by the apparatus 100.

FIG. 4 illustrates the ratings computer 30 of FIG. 1, in block diagram form. With reference to FIG. 4, the ratings computer 30 includes a central processing unit or CPU 30A, which in the preferred embodiment, is a microprocessor. The CPU 30A may also be a microcomputer, a minicomputer, a macro-computer, and/or a mainframe computer, depending upon the application.

The ratings computer 30 also includes a random access memory device(s) (RAM) 30B and a read only memory device(s) (ROM) 30C, each of which is connected to the CPU 30A, a user input device 30D which is connected to the CPU 30A, for entering data and/or commands into the ratings computer 30, and which includes any one or more of a keyboard, a scanner, a user pointing device, such as, for example, a mouse, a touch pad, and/or an audio input device and/or a video input device, etc., if desired. The input device(s) is also connected to the CPU 30A. The ratings computer 30 also includes an output device 30E such as a printer, a modem, a fax/modem, or other output device, which is connected to the CPU 30A, and which provides data and/or information to the operator or user of the ratings computer 30 or to a third party or third party entity. The ratings computer 30 also includes a display device 30F, which is connected to the CPU 30A, which displays data and/or information to a user or operator.

The ratings computer 30 also includes a receiver 30G, which is also connected to the CPU 30A, and which can include one receiver or any number of receivers, for receiving signals and/or data and/or information from any one or more of the central processing computer(s) 10, the programming input/live feed system 15, the news/information content computer 20, the content provider communication device 25, any other the ratings computer(s) 30, the ratings provider communication device(s) 35, the advertisement/marketing computer 40, the advertisement/marketing provider communication device 45, the television 60 or any number of televisions 60 serviced by the apparatus 100, the personal computer 70 or any number of personal computers 70 serviced by the apparatus 100, and/or the cellular or wireless communication device 80 or any number of cellular or wireless communication devices 80 serviced by the apparatus 100.

The ratings computer 30 also includes a database 30H which can store any and/or all data and/or information needed or required for performing any and/or all of the operations and functions described herein as being performed by, or provided by, the apparatus 100 and method the present invention and/or by the ratings computer 30.

The database 30H can also contain or include data and/or information regarding the television ratings for all programming, television programs or shows, television news programs or shows, television news magazines and documentaries, sports and/or sporting programs or shows, cultural and/or artistic programs or shows, and/or any other type of programs, shows, or programming (hereinafter referred to as “programming”), advertisements and/or commercials, marketing information, and/or any other programs, shows, broadcasts, etc., provided via each television station, television network, group of television stations, or group of television networks, serviced by the apparatus 100 and method of the present invention.

The information regarding the television ratings can, for example, include Nielsen ratings information and/or other ratings information provided by third party sources, which can be submitted via a respective ratings provider communication device 35, and/or the information regarding the television ratings can be provided by the respective television station, television network, group of television stations, or group of television networks, serviced by the apparatus 100 and method of the present invention, via a respective central processing computer 10.

The information regarding television ratings can include any conventional ratings information as well as ratings obtained from polling or interrogating each individual's, user's, customer's, entity's, or subscriber's, television 60, personal computer 70, and/or cellular or wireless communication device 80 via the central processing computer 10, in a periodic manner.

For example, in a preferred embodiment, the central processing computer 10 can transmit a polling signal or an interrogation signal to an individual's, user's, customer's, entity's, or subscriber's, television 60, personal computer 70, and/or cellular or wireless communication device 80 during programming. This polling signal or interrogation signal can be transmitted to the individual's, user's, customer's, entity's, or subscriber's, television 60, personal computer 70, and/or cellular or wireless communication device 80 every minute, every 30 seconds, or at any other desired time interval during a program or show so as to poll or monitor the individual's, user's, customer's, entity's, or subscriber's, behavior during the program or show. The individual's, user's, customer's, entity's, or subscriber's, television 60, personal computer 70, and/or cellular or wireless communication device 80, can transmit a reply signal back to the central processing computer 10 in response to each polling signal or interrogation signal.

The reply signal(s) can contain information regarding the television channel or program or show being shown on the individual's, user's, customer's, entity's, or subscriber's, television 60, personal computer 70, and/or cellular or wireless communication device 80 at that point in time. The information received can then be compiled so as to provide real-time polling or monitoring of the behavior of the individual, user, customer, entity, or subscriber, and/or for determining real-time rating information regarding the respective program or show.

The database 30H can also contain or include ratings information regarding advertisements and commercials, as well as ratings information regarding any marketing information transmitted or broadcast to an individual's, user's, customer's, entity's, or subscriber's, television 60, personal computer 70, and/or cellular or wireless communication device 80.

The database 30H can also contain or include data and/or information regarding any of the herein-described ratings information for any and all of the television programming, programs, and/or shows, broadcast by the television stations and television networks serviced by the apparatus 100, as well as ratings information for the television stations and networks. The database 30H can also contain data and/or information comparing the ratings information for each of the television programming, programs, and/or shows, broadcast by the television stations and television networks, as well as information comparing ratings information for the television stations and television networks.

The database 30H can also contain or include data and/or information regarding any ratings information for any and all of the television stations and television networks serviced via the apparatus 100 and method of the present invention, as well as information comparing the ratings information for each of the television stations and/or television networks. The data and/or information stored in the database 30H can be accessed by any television station or television network which utilizes the apparatus 100 and method of the present invention.

The database 30H can also include any other ratings data and/or information needed and/or desired for performing any and/or all of the operations and functions described herein as being performed, or provided by, the apparatus 100 and method of the present invention.

The database 30H can also contain or include any of the data and/or information described herein as being input into the ratings computer 30 or the apparatus 100 or any of its component computers or devices, as being processed by the ratings computer 30 or the apparatus 100 or any of its component computers or devices, and/or as being generated by the ratings computer 30 or the apparatus 100 or any of its component computers or devices.

The ratings computer 30 also includes a transmitter(s) 30I, which is connected to the CPU 30A, and which can include one transmitter or any number of transmitters, for transmitting signals and/or data and/or information to any one or more of the central processing computer 10, the programming input/live feed system 15, the news/information content computer 20, the content provider communication device 25, any other ratings computer(s) 30, the ratings provider communication device(s) 35, the advertisement/marketing computer 40, the advertisement/marketing provider communication device 45, the television 60 or any number of televisions 60 serviced by the apparatus 100, the personal computer 70 or any number of personal computers 70 serviced by the apparatus 100, and/or the cellular or wireless communication device 80 or any number of cellular or wireless communication devices 80 serviced by the apparatus 100.

FIG. 5 illustrates the advertisement/marketing computer 40 of FIG. 1, in block diagram form. With reference to FIG. 5, the advertisement/marketing computer 40 includes a central processing unit or CPU 40A, which in the preferred embodiment, is a microprocessor. The CPU 40A may also be a microcomputer, a minicomputer, a macro-computer, and/or a mainframe computer, depending upon the application.

The advertisement/marketing computer 40 also includes a random access memory device(s) (RAM) 40B and a read only memory device(s) (ROM) 40C, each of which is connected to the CPU 40A, a user input device 40D which is connected to the CPU 40A, for entering data and/or commands into the advertisement/marketing computer 40, and which can include any one or more of a keyboard, a scanner, a user pointing device, such as, for example, a mouse, a touch pad, and/or an audio input device and/or a video input device, etc., if desired. The input device(s) is also connected to the CPU 40A. The advertisement/marketing computer 40 also includes an output device 40E such as a printer, a modem, a fax/modem, or other output device, which is connected to the CPU 40A, and which provides data and/or information to the operator or user of the advertisement/marketing computer 40 or to a third party or third party entity. The advertisement/marketing computer 40 also includes a display device 40F, which is connected to the CPU 40A, which displays data and/or information to a user or operator.

The advertisement/marketing computer 40 also includes a receiver 40G, which is also connected to the CPU 40A, and which can include one receiver or any number of receivers, for receiving signals and/or data and/or information from any one or more of the central processing computer(s) 10, the programming input/live feed system 15, the news/information content computer 20, the content provider communication device 25, the ratings computer 30, the ratings provider communication device 35, any other advertisement/marketing computer(s) 40, the advertisement/marketing provider communication device(s) 45, the television 60 or any number of televisions 60 serviced by the apparatus 100, the personal computer 70 or any number of personal computers 70 serviced by the apparatus 100, and/or the cellular or wireless communication device 80 or any number of cellular or wireless communication devices 80 serviced by the apparatus 100.

The advertisement/marketing computer 40 also includes a database 40H which can store any and/or all data and/or information needed or required for performing any and/or all of the operations and functions described herein as being performed by, or provided by, the apparatus 100 and method the present invention and/or by the advertisement/marketing computer 40.

The database 40H can include advertisements and/or commercials, including television, Internet, and/or video and audio, commercials, infomercials, video advertisements, video clips, audio advertisements, audio clips, banner advertisements, button advertisements, text advertisements, graphical, banner and/or button, advertisements, audio-visual advertisements, interactive advertisements of any of the above-described variety, dynamic advertisements, static advertisements, advertisements which can be placed on web pages and/or on frames surrounding viewed or viewable content, logos, icons, and/or any other information which can be utilized as an advertisement or commercial, as well as any data, information, and/or files, etc., regarding same. The advertisements or commercials can be for or corresponding to any good, goods, product, products, service, and/or services.

The database 40H can also contain or include the prices for advertisement time slots or advertisement slots which are offered by, or charged by, each television station, television network, group of television stations, or group of television networks, which are serviced by the apparatus 100 and method of the present invention to run or place an advertisement or commercial.

The database 40H can also contain or include information regarding the prices which advertisers are willing to pay to place their respective advertisements or commercials. The database 40H can also contain data and/or information regarding success rates for the various advertisements or commercials stored in the database 40H.

The database 40H can also include information regarding affiliated marketing relationships which can be entered into between an advertiser(s) and a television station(s), television network(s), group of television stations, or group of television networks, as well as information for establishing and servicing these affiliated marketing relationships.

The database 40H can also include marketing materials which can include, but not be limited to, surveys, polls, polling information, and/or questionnaires, such as text surveys, polls, polling information, and/or questionnaires, video surveys, polls, polling information, and/or questionnaires, audio surveys, polls, polling information, and/or questionnaires, graphical, banner and/or button, surveys, polls, polling information, and/or questionnaires, audio-visual surveys, polls, polling information, and/or questionnaires, interactive surveys, polls, polling information, and/or questionnaires, of any of the above-described variety, dynamic surveys, polls, polling information, and/or questionnaires, static surveys, polls, polling information, and/or questionnaires, along with the amounts of compensation, the reward, the rebate, and/or the incentive, for viewing, and/or for participating in, the respective surveys, polls, polling information, and/or questionnaires. The database 40H can also contain any data and/or information for or regarding calculating a respective compensation, reward, rebate, and/or incentive, for any individual, user, customer, entity, or subscriber, who has viewed and/or participated in a survey, poll, and/or questionnaire.

The database 40H can also contain any other materials or information which can be utilized in performing marketing research, market research, marketing planning and strategic planning, and/or any other information which can be used for gathering marketing information. The database 40H can also contain data and/or information regarding the preferences of any individuals, users, customers, entities, or subscribers, of the apparatus 100 to receive and/or to participate in certain surveys, polls, and/or questionnaires, data and/or information correlating surveys, polls, polling information, and/or questionnaires, with the purchase or sale of certain goods, products, and/or services, and/or any other data and/or information needed and/or desired for facilitating the operation of the apparatus and method of the present invention as described herein.

The database 40H can also contain data and/or information regarding advertising time slots or advertising slots in programming provided via the apparatus 100 and method of the present invention.

The database 40H can also contain data and/or information for providing options for buying advertisement slots in programming and/or for selling options for advertisement slots in programming.

The database 40H can also contain data and/or information for selling advertisement time slots or advertisement slots in programming as well as for providing a secondary marketplace or clearinghouse for selling or purchasing advertisement time slots or advertisement slots.

The database 40H can also include any other advertisement, commercial, and/or marketing, information needed and/or desired for performing any and/or all of the operations and functions described herein as being performed or provided by the apparatus 100 and method of the present invention.

The database 40H can also contain or include any of the data and/or information described herein as being input into the advertisement/marketing computer 40 or the apparatus 100 or any of its component computers or devices, as being processed by the advertisement/marketing computer 40 or the apparatus 100 or any of its component computers or devices, and/or as being generated by the advertisement/marketing computer 40 or the apparatus 100 or any of its component computers or devices.

The advertisement/marketing computer 40 also includes a transmitter(s) 40I, which is connected to the CPU 40A, and which can include one transmitter or any number of transmitters, for transmitting signals and/or data and/or information to any one or more of the central processing computer(s) 10, the programming input/live feed system 15, the news/information content computer 20, the content provider communication device 25, the ratings computer 30, the ratings provider communication device 35, any other advertisement/marketing computer(s) 40, the advertisement/marketing provider communication device(s) 45, the television 60 or any number of televisions 60 serviced by the apparatus 100, the personal computer 70 or any number of personal computers 70 serviced by the apparatus 100, and/or the cellular or wireless communication device 80 or any number of cellular or wireless communication devices 80 serviced by the apparatus 100.

It is important to note that the television 60 and/or any other television 60 or televisions 60 serviced by the apparatus 100, that the personal computer 70 and/or any other personal computer 70 or personal computers 70 serviced by the apparatus 100, and that the cellular or wireless communication device 80 and/or any other cellular or wireless communication device 80 or cellular or wireless communication devices 80 serviced by the apparatus 100, can include a receiver or any number of receivers for receiving signals and/or data and/or information from any one or more of the central processing computer(s) 10, the programming input/live feed system(s) 15, the news/information content computer(s) 20, the content provider communication device(s) 25, the ratings computer(s) 30, the ratings provider communication device(s) 35, the advertisement/marketing computer(s) 40, the advertisement/marketing provider communication device(s) 45, the television(s) 60 serviced by the apparatus 100, the personal computer(s) 70 serviced by the apparatus 100, and/or the cellular or wireless communication device(s) 80 serviced by the apparatus 100.

The television 60 and/or any other television 60 or televisions 60 serviced by the apparatus 100, the personal computer 70 and/or any other personal computer 70 or personal computers 70 serviced by the apparatus 100, and the cellular or wireless communication device 80 and/or any other cellular or wireless communication device 80 or cellular or wireless communication devices 80 serviced by the apparatus 100, can include a transmitter or any number of transmitters for transmitting signals and/or data and/or information to any one or more of the central processing computer(s) 10, the programming input/live feed system(s) 15, the news/information content computer(s) 20, the content provider communication device(s) 25, the ratings computer(s) 30, the ratings provider communication device(s) 35, the advertisement/marketing computer(s) 40, the advertisement/marketing provider communication device(s) 45, the television(s) 60 serviced by the apparatus 100, the personal computer(s) 70 serviced by the apparatus 100, and/or the cellular or wireless communication device(s) 80 serviced by the apparatus 100.

In a preferred embodiment, the respective central processing computer(s) 10, the news/information content computer(s) 20, the ratings computer(s) 30, and the advertisement/marketing computer(s) 40, can be linked to each other so that updates to the respective databases 20H, 30H, and 40H can be automatically uploaded or transmitted to, and stored in, the database 10H of the central processing computer(s) 10, and so that any updates to the database 10H can be automatically uploaded or transmitted to, and stored in, each of the databases 20H, 30H, and 40H.

In a preferred embodiment, the apparatus 100 and method of the present invention can be utilized to provide a comprehensive news and/or information content database which can store, and/or serve as a global, national, regional, and/or local, repository for news and/or information which can be received from any one or more of any number of content sources or contributing entities or individuals, including, but not limited to, a news service, a news reporting agency, a television station, a radio station, a newspaper, a magazine, a journal, an Internet and/or a World Wide Web content source or provider, a reporter, an author, a research institution or a laboratory, a university, a college, a school and/or any other institution of learning, a journalist, a freelance journalist, and/or an individual or any individual who desires to provide news or information for dissemination via the apparatus 100 and method of the present invention. In a preferred embodiment, the news and information stored in the comprehensive news and/or information content database can be stored or deposited into the comprehensive news and/or information database by any of the herein-described content source or contributing entities or individuals. The deposited news or information can then be purchased for use or dissemination by any appropriate entity or individual, with payment being made to the respective content source or contributing entity or individual.

In this manner, the present invention can be utilized to provide a comprehensive news and/or information database which can provide a means by which news and/or information can be collected in a global, national, regional, and/or local, manner, and can be made available for use or dissemination by a respective entity or individual. The comprehensive news and/or information database can also be utilized to sell content and to serve as a revenue generation source for the content provider or contributing entity or individual which or who provides the respective news or information.

In a preferred embodiment, the comprehensive news and/or information database can be located in the database 10H of the central processing computer 10 and/or in the database 20H of the news/information content computer 20 and can include data and/or information regarding accounts for entities and/or individuals which or who can contribute and/or deposit news stories and/or information to the comprehensive news and/or information database as well as accounts for entities and/or individuals which or who can subscribe to the services of the comprehensive news and/or information database in order to obtain news stories and/or other information or content therefrom. For example, an entity or an individual, such as, for example, a news reporting service or entity or an individual such as, for example, a freelance journalist or other person, (hereinafter referred to as a “contributor”) can establish an account with the apparatus 100, make a contribution(s) of a news story or news stories or other information or content, and be compensated for the contribution(s). An entity such as, for example, a television news show, an Internet content provider, a radio program, a magazine, or a newspaper, or any individual or person (hereinafter referred to as an “individual or subscriber”) can obtain news stories or information or content which has been deposited in and stored in the comprehensive news and/or information database.

The news stories and/or information or content contributed by the respective contributors can originate from anywhere in the World and can be provided to any individual or subscriber. In this manner, the present invention can provide a comprehensive news and/or information database wherein news stories and/or information or content, which originates any where in the World, can reside in a single database system for retrieval and/or use by any individual or subscriber who utilizes the present invention. In a preferred embodiment, news stories and/or information or content can be transmitted to, as well as transmitted from, the comprehensive news and/or information database via, on, or over, the Internet and/or the World Wide Web. Contributors can be compensated for each contribution made or can be compensated pursuant to a retainer arrangement or agreement whereby they can be expected to make contributions on a regular basis for a pre-determined period of time. Contributors can also be compensated each time a news story or information or content is retrieved by, provided to, and/or used by, an individual or subscriber.

The apparatus 100, the central processing computer 10, and/or the news/information content computer 20, can process any and all transactions relating to the comprehensive news and/or information database, as well as effect any and all financial transactions relating to the use of same. The apparatus 100, the central processing computer 10, and/or the news/information content computer 20, can, for example, process any and all information for making a payment from an individual's or subscriber's financial account to a financial account corresponding to a contributor of a news story or information or content purchased.

In a preferred embodiment, an individual or subscriber, which can also be or include a television news show, an Internet content provider, a radio program, a magazine, or a newspaper, or any individual or person, can access the comprehensive news and/or information database, such as by accessing the central processing computer 10 or the news/information content computer 20 via a television 60, personal computer 70, and/or cellular or wireless communication device 80 associated with or used by the individual or subscriber. The individual or subscriber can then enter a search request which can include search criteria for searching the comprehensive news story or information database by story or information subject or topic, by story or information source or origin, by reporter or author, by date, by description, and/or by any other appropriate search criteria, which search criteria will be used in order to identify and retrieve one or more news stories or information stored in the comprehensive news and/or information database. The central processing computer 10 or the news/information content provider computer 20 can thereafter process the entered search request, generate a report containing any news story or stories or information or content responsive to the search request, and transmit the report containing one of more news stories or information or content to the television 60, personal computer 70, and/or cellular or wireless communication device 80 associated with the individual or subscriber.

The individual or subscriber can then select the news story or new stories or information or content which he/she/it desires to purchase or utilize. Thereafter, payment for the retrieval, the use, or the providing, of the news story or stories or the information or content can be made to a financial account associated with the contributor of the news story or information or content. In the case of a television news program or show, an Internet content provider, a radio program, a magazine, or a newspaper, or other entity which may have or operate its own central processing computer 10, the search request may be made transmitted to the news/information content computer 20 via the input device 10D of the central processing computer 10. It is important to note, however, that a television news program or show, an Internet content provider, a radio program, a magazine, or a newspaper, can also have associated therewith, and can utilize, a television 60, personal computer 70, and/or cellular or wireless communication device 80.

In another preferred embodiment, the apparatus 100 and the comprehensive news and/or information database can be utilized to provide real-time or immediate alerts to individuals or subscribers when a news story or information or content of interest to the individual or subscriber is posted to, or stored in, the comprehensive news and/or information database.

FIG. 6 illustrates a method for using the apparatus 100 of the present invention to request and receive alerts regarding news stories or information, in flow diagram form. With reference to FIG. 6, the operation of the apparatus 100 commences at step 600. At step 601, an individual or subscriber to the comprehensive news and/or information database can access the central processing computer 10 or the news/information content computer 20 via the television 60, personal computer 70, or cellular or wireless communication device 80 associated with or used by the individual or subscriber. If the individual or subscriber is a television news program or show, an Internet content provider, a radio program, a magazine, or a newspaper, having its own central processing computer 10, it can also access the news/information content computer 20 or a central processing computer 10 associated with another television news program or show, an Internet content provider, a radio program, a magazine, or a newspaper, via its central processing computer 10.

At step 602, the individual or subscriber can enter the alert request which can include search criteria for the news story or information or content about which the individual or subscriber desires to receive an alert message. At step 603, the central processing computer 10 or the news/information content computer 20, whichever is utilized by the individual or subscriber, can store the information regarding the alert request. At step 604, the central processing computer 10 or the news/information content computer 20, whichever is utilized by the individual or subscriber, can await a posting or a storing or a news story or information or content in the comprehensive news and/or information database in the database 10H or the database 20H, whichever is being utilized.

Upon detecting a posting, or a storing of, a news story or information or content in the comprehensive news and/or information database in the database 10H or in the database 20H, the central processing computer 10, if utilized, or the news/information content computer 20, if utilized, will, at step 605, perform an appropriate search and identify the newly posted or stored news story or information or content and, at step 606, the central processing computer 10 or the news/information content computer 20, whichever is utilized, will generate an alert message containing the newly posted or stored news story or information or content. At step 606, an advertisement may also be included in the alert message.

At step 607, the alert message is then transmitted from the central processing computer 10, or from the news/information content computer 20, whichever is utilized, to any one or more of the individual's or subscriber's television 60, personal computer 70, or cellular or wireless communication device 80, and information contained in the alert message can be provided to, or viewed by, the individual or subscriber. If the individual or subscriber has a central processing computer 10 associated therewith, the alert message can also be transmitted the central processing computer 10.

In the event that the individual or subscriber is viewing a television show or program, or is utilizing a personal computer or a cellular or wireless communication device, the alert message can either be displayed in a picture-in-picture manner, or the television program or show can be halted, with the programming being recorded for later display so that the alert message can be displayed to the individual or subscriber, without the individual or subscriber missing any of the television program or show. In another preferred embodiment, a text or graphical indication can be provided on the screen of the respective television 60, personal computer 70, and/or cellular or wireless communication device 80, which can inform the individual or subscriber that an alert message has been received and can be viewed at the individual's or subscriber's convenience. Thereafter, the operation of the apparatus 100 will cease at step 608.

In the above-described manner, a real-time or immediate news alert or information or content alert can be provided to an individual or a subscriber. In the case where the individual or subscriber is a television news program or show, an Internet content provider, a radio program, a magazine, or a newspaper, the herein-described alert message feature of the present invention can be utilized to supplement its own news gathering resources. Also, in the case where the television news program or show, Internet content provider, radio program, magazine, or newspaper, is the contributor of the news story or information or content which is the subject of the alert, the respective television news show, Internet content provider, radio program, magazine, or newspaper, can receive compensation for the alert message as well as provide self-advertising in same.

In another preferred embodiment, the apparatus 100 and method of the present invention can generate and provide personal news report to individuals or subscribers which can contain a news story, news stories, or information or content, which is of interest to the individual or subscriber. In a preferred embodiment, an individual or subscriber can create a personal news account by which the individual or subscriber can request to receive one or more personal news reports. An individual or subscriber can request, at any time, to receive a personal news report containing news or information or content regarding any topic or subject of interest to the individual or subscriber.

For example, an individual or subscriber interested in receiving a news report pertaining to a development in the financial or investment markets may request to receive a news report containing a news story or news stories regarding a development in the financial or investment markets. Similarly, an individual or subscriber interested in receiving a news report pertaining to a development in the field of healthcare, health, medicine, dentistry, fitness, or wellness, can request to receive a news report containing a news story or news stories regarding a development in healthcare, health, medicine, dentistry, fitness, or wellness. Likewise, an individual or subscriber can request to receive a personal news report regarding breaking World news, national news, regional news, local news, and/or an emergency broadcast, and/or news or information or content regarding politics, business, finance, technology, law, crime, entertainment, travel, living and/or human interest, sports, consumer information, weather, traffic, education, and/or any other subject or topic for which news or information my be reported.

The individual or subscriber can access the central processing computer 10 and/or the news/information content computer 20 and sign-up to receive personal news reports. The individual or subscriber can also sign-up to receive one or more personal news reports on one or more topics or subjects. In a preferred embodiment, any of the personal news reports can contain video clips, audio clips, clips containing both audio and video, text, and/or any combination of same. The personal news reports can be transmitted to any one or more of the television 60, the personal computer 70, and/or the cellular or wireless communication device 80, associated with, or used by, the individual or subscriber. In the case of a personal news report being transmitted to a television 60, the personal news report can be transmitted to the television 60 via, on, or over, a video-on-demand channel associated with, or utilized by, the central processing computer 10. Any and/or all of the personal news reports provided by the apparatus 100 can also include an advertisement or advertisements.

FIG. 7 illustrates a method for using the apparatus 100 of the present invention to request and receive personal news reports, in flow diagram form. With reference to FIG. 7, the operation of the apparatus 100 commences at step 700. At step 701, an individual or subscriber can access the central processing computer 10 or the news/information content computer 20, via the television 60, personal computer 70, or cellular or wireless communication device 80, associated with, or utilized by, the individual or subscriber.

At step 702, the individual or subscriber can enter a personal news report request which can include the topic or subject for which he or she desires to receive a personal news report pursuant to his or her personal news account. At step 702, the individual or subscriber can request to receive any number of personal news reports. At step 703, the central processing computer 10 or the news/information content computer 20, whichever is utilized by the individual or subscriber, can store the information regarding the personal news report(s) request(s).

At step 704, the central processing computer 10 or the news/information content computer 20, whichever is utilized by the individual or subscriber, can await either a posting or a storing or a news story or information or content, relating to the topic or subject of the personal news report request, in the comprehensive news and/or information database in the database 10H or in the database 20H, whichever is being utilized. Upon detecting a posting or a storing of a news story, news stories, or information or content, relating to the topic or subject of the personal news report request, in the comprehensive news and/or information database in the database 10H or the database 20H, the central processing computer 10, or the news/information content computer 20, whichever is utilized, will, at step 705, generate the requested personal news report.

In another preferred embodiment and/or in the alternative, at step 704, the central processing computer 10 or the news/information content computer 20, can be programmed to periodically query their respective databases 10H or 20H, at pre-determined periodic time intervals which can be selected by the individual or subscriber or selected by an operator of the apparatus 100, and, if a news story, news stories, or information or content, pertinent to the personal news story request is identified, the central processing computer 10 or the news/information content computer 20, whichever is utilized, will generate the personal news report at step 705.

The personal news report(s) can contain video clips, audio clips, clips containing both audio and video, text, and/or any combination of same. At step 706, the central processing computer 10 or the news/information content computer 20, whichever is utilized, will then store the personal news report in the respective database 10H or 20H, for later retrieval by the individual or subscriber. If stored in the database 20H of the news/information content computer 20, the personal news report can be transmitted to the central processing computer 10 for storage in the database 10H.

At step 706, the central processing computer 10 or the news/information content computer 20, whichever is utilized, can also generate a personal news report alert message to notify the individual or subscriber of the availability of his or her personal news report, and can transmit same to the television 60, personal computer 70, or cellular or wireless communication device 80, associated with, or utilized by, the individual or subscriber.

At step 707, the individual or subscriber can access the central processing computer 10 and, via the television 60, personal computer 70, or cellular or wireless communication device 80, he or she can retrieve and receive his or her personal news report. In the preferred embodiment, at step 707, the personal news report can be transmitted to the television 60, the personal computer 70, or the cellular or wireless communication device 80, via a video-on-demand channel associated with, or provided or utilized by, the central processing computer 10. Thereafter, information contained in the personal news report can be provided to, or viewed by, the individual or subscriber. In a preferred embodiment, the personal news report can contain one news story, a plurality of news stories, or information or content. In a preferred embodiment, the personal news story can also contain an advertisement or a number of advertisements. In a preferred embodiment, the advertisement or advertisements, which can be provided in the personal news report or personal news reports described herein, can be selected based on the personal interests, demographics, age, gender, race, other individual or subscriber provided information, and/or other information descriptive of, the respective individual or subscriber. Thereafter, the operation of the apparatus 100 will cease at step 708.

In another preferred embodiment, the apparatus 100 and method of the present invention can be utilized to allow an advertiser, such as a merchant or vendor of a good, product, or service, or an agent of, or a third party acting on behalf of, the advertiser, to purchase, in an on-line and/or in a real-time environment, an advertisement time slot(s) or advertisement slot(s) in a pre-recorded or live digital television broadcast, program, or show, which is broadcast or transmitted from or via the apparatus 100 of the present invention. For example, an advertiser or an agent of, or a third party acting on behalf of, the advertiser, can, via the advertisement/marketing provider communication device 45, or via a television 60, personal computer 70, or cellular or wireless communication device 80, associated with, or used by, the advertiser, agent, or third party, access the central processing computer 10 for a given television station, television network, group of television stations, or group of television networks, and request that information regarding any television programming, program, or show, (hereinafter “programming”) scheduled to be broadcast or transmitted by the central processing computer 10 and/or by a respective television station or channel, be provided to the television 60, personal computer 70, or cellular or wireless communication device 80 associated with, or used by, the individual or subscriber.

The information regarding the programming can be provided and can include, for each television program or show, the available advertising time slots or advertising slots in the programming wherein commercials can be inserted into the broadcast or transmission to the television 60, personal computer 70, or cellular or wireless communication device 80 associated with, or used by, the individual or subscriber. The information regarding the programming can also include a description of the programming, program, or show, individuals or celebrities appearing in the programming, program, or show, and information regarding the rating or ratings for each respective television program or show and/or for the individuals or celebrities appearing in the programming, program, or show.

The advertiser, agent, or third party, can select and purchase an advertising time slot(s) or advertising slot(s) in the respective television program or show. The advertiser, agent, or third party, can also transmit or upload to the central processing computer 10, or select from the advertisement/marketing computer 40 for upload to and transmission to the central processing computer 10, an advertisement(s) or commercial(s) containing any one or more of video information, audio information, or text information. The advertisement(s) or commercial(s) selected can be transmitted to or uploaded to the central processing computer 10, for transmission to and storage in the database 10H of the central processing computer 10. In this manner, an advertiser, agent, or third party, can purchase an advertising time slot(s) or advertising slot(s) and select and insert the advertisement(s) or commercial(s) which is/are to be broadcast or transmitted in the respective slot(s). The central processing computer 10 can also process any financial transaction(s) regarding the purchase and/or the sale of the advertisement time slot(s) or advertisement slot(s).

In another preferred embodiment, the apparatus 100 of the present invention can also be utilized to create a secondary marketplace or clearinghouse for advertisement time slots or advertisement slots. In this manner, an advertiser, agent, or third party, can offer for sale an advertising time slot(s) or advertising slot(s) which they have already purchased and continue to hold. In another preferred embodiment, the apparatus 100 can be utilized to create an advertising time slot option or an advertising slot option (hereinafter “advertising option”) which can be an option(s) derived from the respective advertising time slot(s) or advertising slot(s). An advertiser, agent, or third party, can, for example, sell an advertising option obligating it to sell an advertising time slot or an advertising slot at a pre-determined price for a pre-determined time period. In a similar manner, an advertiser, agent, or third party, can, for example, buy an advertising option which will provide it with the right to purchase an advertising time slot or an advertising slot at a pre-determined price for a pre-determined time period.

FIG. 8 illustrates a method for using the apparatus 100 of the present invention to purchase an advertising time slot(s) or an advertising slot(s) in television programming, in an on-line or real-time environment, in flow diagram form. With reference to FIG. 8, the operation of the apparatus 100 commences at step 800. At step 801, an advertiser, agent, or third party, can, via the advertisement/marketing provider communication device 45, or via a television 60, personal computer 70, or cellular or wireless communication device 80, used by the advertiser, agent, or third party, access the central processing computer 10 for a given television station, television network, group of television stations, or group of television networks.

At step 802, the advertiser, agent, or third party, can transmit a request to receive information regarding any television programming, program, or show, (hereinafter “programming”) scheduled to be broadcast or transmitted by the central processing computer 10, and/or by a respective television station or channel, to the television 60, personal computer 70, or cellular or wireless communication device 80 associated with, or used by, the individual or subscriber.

At step 803, the central processing computer 10 can receive and process the request to receive information. At step 804, the central processing computer 10 can transmit, to the advertisement/marketing provider communication device 45, the television 60, the personal computer 70, and/or the cellular or wireless communication device 80, whichever is utilized, the requested information regarding the programming. The requested information regarding the programming can include, for each television program or show, the available advertising time slots or advertising slots in the programming schedule wherein an advertisement(s) or commercial(s) can be inserted into the broadcast or transmission of the television program or show. The requested information regarding the programming can be transmitted to the television 60, personal computer 70, or cellular or wireless communication device 80 used by the individual or subscriber. The information regarding the programming can also include a description of the programming, program, or show, individuals or celebrities appearing in the programming, program, or show, and information regarding the rating or ratings for each respective television program or show and/or for the individuals or celebrities appearing in the programming, program, or show.

At step 805, the advertiser, agent, or third party, can select and purchase an advertising time slot(s) or advertising slot(s) in the respective schedule of the television program or show. At step 805, the advertiser, agent, or third party, can also transmit or upload to the central processing computer 10, or select from the advertisement/marketing computer 40 for uploading or transmission to the central processing computer 10, an advertisement(s) or commercial(s) to fill the advertising time slot(s) or advertising slot(s). The advertisement(s) or commercial(s) can contain any one or more of video information, audio information, or text information. The advertisement(s) or commercial(s) can be transmitted or uploaded to the central processing computer 10, for transmission to, and storage in, the database 10H of the central processing computer 10. In this manner, an advertiser, agent, or third party, can purchase an advertising time slot(s) or advertising slot(s) and insert the advertisement(s) or commercial(s) to be broadcast or transmitted in the advertising time slot(s) or advertising slot(s).

At step 806, the central processing computer 10 can determine whether or not the advertiser, agent, or third party, requested to purchase an advertising time slot(s) or advertising slot(s). If, at step 806, the central processing computer 10 determines that the advertiser, agent, or third party, has selected to purchase an advertising time slot(s) or advertising slot(s), then the central processing computer 10 will, at step 807, process any financial transaction(s) regarding the purchase and/or sale of the advertising time slot(s) or advertising slot(s). If, at step 806, it is determined that the advertiser, agent, or third party, does not desire to purchase an advertising time slot(s) or advertising slot(s), then the operation of the apparatus will cease at step 811.

As noted herein, the apparatus 100 of the present invention can also be utilized to create a secondary marketplace or clearinghouse for advertisement time slots or advertisement slots. In this manner, an advertiser, agent, or third party, can offer for sale an advertising time slot(s) or advertising slot(s) which they have already purchased and continue to hold. In another preferred embodiment, the apparatus 100 can be utilized to create an advertising time slot option(s) or an advertising slot option(s) (hereinafter “advertising option” or “advertising options”) which can be options derived from the respective advertising time slot(s) or advertising slot(s). An advertiser, agent, or third party, can, for example, sell an advertising option obligating it to sell an advertising time slot or an advertising slot at a pre-determined price for a pre-determined time period. In a similar manner, an advertiser, agent, or third party, can, for example, buy an advertising option which will provide it with the right to purchase an advertising time slot or an advertising slot at a pre-determined price for a pre-determined time period.

At step 808, the advertiser, agent, or third party, can select to make the advertising time slot(s) or advertising slot(s) just purchased, or to make any previously purchased advertising time slot(s) or advertising slot(s), available for sale at a pre-selected sale price or prices. At step 808, the advertiser, agent, or third party, can also select to create, and make available for sale, an advertising option(s) for the newly purchased advertising time slot(s) or advertising slot(s) or to create, and make available for sale, an advertising option(s) for a previously purchased advertising time slot(s) or advertising slot(s). At step 808, the advertiser, agent, or third party, can specify an offering sale price for each advertising time slot(s) or advertising slot(s), and/or can specify a price for each advertising option as well as the option exercise price for each advertising option. At step 809, the information regarding the advertiser's, the agent's, or the third party's, selection to make the respective advertising time slot(s) or advertising slot(s) available for sale and/or to create, and make available for sale, the respective advertising option(s) described herein, will be transmitted to and received by the central processing computer 10.

At step 810, the information regarding the advertiser's, the agent's, or the third party's, selection to make the respective advertising time slot(s) or advertising slot(s) available for sale and/or to create, and make available for sale, the respective advertising option(s) described herein, along with a specified offering price(s), a specified advertising option price(s), and/or a specified option exercise price(s), will be used to update the information regarding the programming, described herein at step 804.

In a preferred embodiment, information regarding the programming can include, for each television program or show, the available advertising time slots or advertising slots in the programming or programming schedule. Thereafter, the updated information regarding the programming will be available to service a subsequent request to receive information from any individual, advertiser, agent, or third party, and a respective individual, advertiser, agent, or third party, can purchase any advertising time slot(s) or advertising slot(s) offered for resale or can purchase or sell any advertising option(s). The central processing computer 10 can then process any financial transaction(s) for any such transaction(s).

Thereafter, the operation of the apparatus 100 will cease at step 811.

In another preferred embodiment, the apparatus 100, the central processing computer 10, the news/information content computer 20, the ratings computer 30, and/or the advertisement/marketing computer 40, can be programmed to automatically find, identify, and/or purchase, an advertising time slot(s) or advertising slot(s) in a pre-recorded or live digital television broadcast, program, or show, which is broadcast or transmitted via the apparatus 100, and/or can be programmed to automatically find, identify, and/or purchase, an advertising option(s) for same from an advertiser, agent, or third party acting on behalf of an advertiser. In this preferred embodiment, the apparatus 100, the central processing computer 10, the news/information content computer 20, the ratings computer 30, and/or the advertisement/marketing computer 40, can be programmed for automatic activation and/or automatic operation. In another preferred embodiment, the apparatus 100 and the method of the present invention can also utilize intelligent agents, software agents, and/or mobile agents, which can act for, or on behalf of, an advertiser, agent, or third party.

FIGS. 9A and 9B illustrate another preferred embodiment operation of the apparatus 100 of the present invention, in flow diagram form. In the preferred embodiment of FIGS. 9A and 9B, the apparatus 100, the central processing computer 10, the news/information content computer 20, the ratings computer 30, and/or the advertisement/marketing computer 40, can be programmed to find, identify, and/or purchase, an advertising time slot(s) or advertising slot(s) in a pre-recorded or live digital television broadcast, program, or show, which is broadcast or transmitted via the apparatus 100. The apparatus 100, the central processing computer 10, the news/information content computer 20, the ratings computer 30, and/or the advertisement/marketing computer 40, can also be programmed to automatically find, identify, and/or purchase, an advertising option(s) for an advertising time slot(s) or advertising slot(s) for an advertiser, agent, or third party acting on behalf of an advertiser.

With reference to FIGS. 9A and 9B, the operation of the apparatus 100 commences at step 900. At step 901, an advertiser, an agent, or a third party acting on behalf of, the advertiser, can, via the advertisement/marketing provider communication device 45, or via a television 60, personal computer 70, or cellular or wireless communication device 80 used by the advertiser, agent, or third party, access the central processing computer 10 for a given television station, television network, group of television stations, or group of television networks.

At step 902, the advertiser, agent, or third party, can enter information regarding any one or more of a number of parameters, criteria, or instructions, dictating conditions under which the apparatus 100 and/or the central processing computer 10 can and should purchase an advertising time slot(s), advertising slot(s), and/or any advertising option(s) as well as any circumstances which can trigger such activity on behalf of the advertiser, agent, or third party. These parameters or conditions can include information regarding a specified television station or television stations in connection with which the advertiser desires to purchase advertising, television programming, a television program(s), or television show(s), in connection with which the advertiser seeks to purchase advertising, individual actors, performers, and/or celebrities, in connection with which the advertiser seeks to purchase advertising, times of day, times of week, times of month, times of year, a specific day or days, week or weeks, or month or months, in or during which the advertiser seeks to advertise, spending limits on automated advertising time slot or automated advertising slot purchases which can be specified for each advertising time slot or advertising slot, rating requirements, a minimum rating or ratings, or a maximum rating or ratings, for which the advertiser seeks to purchase an advertising time slot or an advertising slot, whether the advertiser desires to purchase an advertising option or options, the specific advertisement or commercial to be placed in an advertising time slot or advertising slot, and/or any other parameter(s) or condition(s) which can be specified by an advertiser, agent, or third party, for finding, identifying, and/or purchasing, an advertising time slot(s) or advertising slot(s).

At step 902, the advertiser, agent, or third party, can also enter information regarding the search event or searching events, the occurrence or existence of which will trigger the central processing computer 10 to perform an advertising time slot search or an advertising slot search. The event or events can be any one or more of, but is not limited to, the occurrence of a change to or in a television station's programming, a change in a program or a show, a change in a programming schedule of a television station, a change in a programming schedule of a program or show, a change in a rating for a television station, a change to a rating of a program or a show of a television station, an availability of an advertising time slot(s) or advertising slot(s), a change to a price or offering of an advertising time slot(s) or advertising slot(s), a purchase of an advertising time slot or an advertising slot by another party, a sale of an advertising time slot or an advertising slot to another party, a posting of an availability of an advertising time slot or an advertising slot for resale by another party, a posting of an availability of an advertising option by another party, and/or any other event or events which may be of interest to an advertiser in deciding to secure or purchase an advertising time slot(s) or an advertising slot(s).

At step 902, the information described herein as being entered by the advertiser, agent, or third party, can be transmitted from the respective advertisement/marketing provider communication device 45, television 60, personal computer 70, or cellular or wireless communication device 80, to the central processing computer 10.

At step 903, the central processing computer 10 will receive and store the information received from the respective advertisement/marketing provider communication device 45, television 60, personal computer 70, or cellular or wireless communication device 80. At step 904, the central processing computer 10 will await the occurrence and/or detection of the searching event.

Upon the occurrence and/or detection of the searching event, the central processing computer 10 will, at step 905, search through the advertising time slots or advertising slots for all of the programming, programs, and/or shows, for each and all television stations for which the advertiser desires to purchase an advertising time slot(s) or an advertising slot(s), and identify those respective advertising time slot(s) or advertising slot(s) which meet the advertiser's parameters, criteria, or instructions. The advertising time slot(s) or advertising slot(s) can be open slots which have not been previously purchased by another party and/or they can be previously purchased slots which are available for resale.

At step 905, the central processing computer 10 can also generate an event notification alert message which can contain information regarding the event which has occurred. The event notification alert message can, for example, contain information regarding any one or more of the occurrence of a change to or in a television station's programming, a change in a program or a show, a change in a programming schedule of a television station, a change in a programming schedule of a program or show, a change in a rating for a television station, a change to a rating of a program or a show of a television station, an availability of an advertising time slot(s) or advertising slot(s), a change to a price or offering of an advertising time slot(s) or advertising slot(s), a purchase of an advertising time slot or an advertising slot by another party, a sale of an advertising time slot or an advertising slot to another party, a posting of an availability of an advertising time slot or an advertising slot for resale by another party, a posting of an availability of an advertising option by another party, and/or any other event or events which may be of interest to an advertiser in deciding to secure or purchase an advertising time slot(s) or an advertising slot(s).

At step 905, the central processing computer 10 can transmit the event notification alert message to the respective advertisement/marketing provider communication device 45, television 60, personal computer 70, or cellular or wireless communication device 80, or to any other advertisement/marketing provider communication device 45, television 60, personal computer 70, or cellular or wireless communication device 80, in real-time or immediately.

Once having identified advertising time slots or advertising slots which are available for purchase, the central processing computer 10, at step 906, can reserve and purchase the advertising time slot(s) or advertising slot(s) for the advertiser. At step 906, for each advertising time slot or advertising slot purchased, the central processing computer 10 can process a financial transaction for effecting payment on behalf of the advertiser to the television station, or third party, for the purchase of each advertising time slot or advertising slot. At step 906, for each advertising time slot or advertising slot purchased, the central processing computer 10 can also designate and store the advertisement(s) or commercial(s) which is to fill the advertising time slot or advertising slot. At step 906, the central processing computer 10 can also search through and identify advertising options which are available for purchase and can purchase one or more advertising options, if appropriate. At step 906, the central processing computer 10 can also generate a slot purchase notification alert message containing information regarding the actions taken on behalf of the advertiser, including the advertisement time slot(s) or advertising slot(s) reserved and purchased, the advertisement(s) or commercial(s) designated for each respective slot and the price paid for same. The slot purchase notification alert message can also include information regarding any advertising option(s) purchased on behalf of the advertiser.

At step 907, the central processing computer 10 can transmit the slot purchase notification alert message to the advertisement/marketing provider communication device 45, television 60, personal computer 70, or cellular or wireless communication device 80, or any other advertisement/marketing provider communication device 45, television 60, personal computer 70, or cellular or wireless communication device 80, associated with the advertiser, agent, or third party. At step 908, information contained in the slot purchase notification alert message can be provided or displayed to the advertiser, agent, or third party. Thereafter, the operation of the apparatus 100 will cease at step 909.

In another preferred embodiment, the apparatus 100 can be utilized to determine and/or gather ratings information for programs, shows, other content, advertisements, or commercials. In a preferred embodiment, the central processing computer 10 can transmit a polling signal or an interrogation signal to an individual's, user's, customer's, entity's, or subscriber's, television 60 or the cable TV box or the set-top box associated with the television 60, personal computer 70, and/or cellular or wireless communication device 80, during programming. This polling signal or interrogation signal can be transmitted to the individual's, user's, customer's, entity's, or subscriber's, television 60 or the cable TV box or the set-top box associated with the television 60, personal computer 70, and/or cellular or wireless communication device 80, every minute, every 30 seconds, or at any other desired time interval during a program, show, or other content, so as to poll or monitor the individual's, user's, customer's, entity's, or subscriber's, behavior during the program, show, or other content. In the case of an advertisement or commercial, the polling signal or interrogation signal can be transmitted at pre-selected intervals such as, for example, every 5 seconds, every 10 seconds, or at any other desired time interval, to account for the relatively short broadcast times of advertisements or commercials.

In the preferred embodiment, the television 60, or the cable TV box or set-top box associated with the television 60, can be adapted to access and/or monitor the circuit or circuits utilized therein which are responsible for displaying or storing data and/or information regarding the television channel on the display screen of the television 60 or on the display of the cable TV box or the set-top box associated with the television 60. Upon the receiving of each polling signal or interrogation signal by the respective television 60, or the cable TV box or the set-top box associated with the television 60, the data and/or information regarding the channel being viewed can be read and stored by the respective television 60, or the cable TV box or the set-top box associated with the television 60, or by the respective circuitry utilized in the television 60 or respective box.

The individual's, user's, customer's, entity's, or subscriber's, television 60 or the cable TV box or the set-top box associated with the television 60, personal computer 70, and/or cellular or wireless communication device 80, in the preferred embodiment, can be programmed to automatically generate a reply signal or message and transmit the reply signal or message back to the central processing computer 10 in response to each polling signal or interrogation signal.

The reply signal(s) or message(s) can contain data and/or information regarding the television channel, program, show, other content, advertisement, or commercial, being shown on or at the individual's, user's, customer's, entity's, or subscriber's, television 60 or the cable TV box or the set-top box associated with the television 60, personal computer 70, and/or cellular or wireless communication device 80, at that point in time. The information received can then be processed and compiled by the central processing computer 10 in order to determine or ascertain information regarding the real-time polling or monitoring of the behavior of the individual, user, customer, entity, or subscriber, and/or for determining real-time rating information regarding the respective program, show, other content, advertisement, or commercial.

The central processing computer 10 can receive and store the data and/or information contained in each reply signal or message and, upon completion of the respective television program, show, other content, advertisement, or commercial, can process the data and/or information received from the reply signals or messages, and determine, assign, and store, a ratings number to the respective television program, show, other content, advertisement, or commercial. The ratings number can be based on ratings numbers or scales typically used in rating television programming and can be based on Nielsen ratings scales and/or any other ratings numbers or scales which are deemed to be appropriate for use in connection with the apparatus 100 and method of the present invention.

By determining the individual's, user's, customer's, entity's, or subscriber's, behavior during the program, show, other content, advertisement, or commercial, such as, for example, whether the individual, user, customer, entity, or subscriber, stayed tuned to the entire program, show, other content, advertisement, or commercial, or whether the individual, user, customer, entity, or subscriber, only stayed tuned for a portion of the program, show, other content, advertisement, or commercial, and if so, what portion, the central processing computer 10 can determine or ascertain a rating for the respective program, show, other content, advertisement, or commercial.

In the preferred embodiment, the ratings information for the respective television program, television show or other television content, or the advertisement or commercial can then be stored in the database 10H of the central processing computer 10 and in the database 30H of the ratings computer.

In the preferred embodiment, each central processing computer 10 utilized in connection with the apparatus 100 can gather ratings data and/or information for each television program, television show, television content, or advertisement or commercial, broadcast or transmitted by the respective television station, television network, group of television stations, or group of television networks, associated with each respective central processing computer 10. The ratings data and/or information can be stored in real-time or immediately in the database 10H of each respective central processing computer 10, as well as can be stored in real-time, immediately, or periodically, in the database 30H of the ratings computer 30. Any and all ratings data and/or information stored in the ratings computer 30 can also be immediately transmitted to, or be made available to, any other central processing computer(s) 10 which are associated with another television station(s), another television network(s), another group of television stations, or another group of television networks.

In this manner, the apparatus 100 of the present invention can be utilized to provide an apparatus and a method for enabling a television station, a television network, a group of television stations, or a group of television networks, to monitor the ratings of its competitors or affiliates or the ratings of the programs, shows, other content, advertisements, or commercials, of its competitors or affiliates. The ratings information obtained and stored in a respective database 10H of the central processing computer 10 and in the database 30H of the ratings computer 30 can be automatically provided, such as in a real-time ratings alert message or as an immediate ratings alert message, to another central processing computer 10 associated with a competitor or an affiliate. Alternatively, the newly stored ratings data and/or information can be retrieved upon request by a competitor or affiliate via the central processing computer 10 or other computer or communication device.

FIG. 10 illustrates another preferred embodiment operation of the apparatus 100 of the present invention, in flow diagram form. In the embodiment of FIG. 10, the apparatus 100 of the present invention, and/or the central processing computer 10, can be used to gather ratings data and/or information regarding a television program, show, other content, advertisement, or commercial, or can be used to gather ratings data and/or information regarding each and every television program, show, other content, advertisement, or commercial, which is provided via the apparatus 100 of the present invention.

With reference to FIG. 10, the operation of the apparatus 100 commences at step 1000. At step 1001, the central processing computer 10 can begin broadcasting or transmitting a program, show, other content, advertisement, or commercial, to a television 60 or the cable TV box or the set-top box associated with the television 60. During the broadcast or transmission of the respective television program, show, other content, advertisement, or commercial, the central processing computer 10, during the duration of the broadcast or transmission, at step 1002, can transmit a plurality of polling signals or interrogation signals to the respective television 60 or the cable TV box or the set-top box associated with the television 60, such as in the manner described herein. The central processing computer 10 can transmit the polling signals or interrogation signals to each television 60 viewing the television channel and/or to each cable TV box or set-top box associated with each television 60 tuned to or viewing the television channel.

At step 1002, the central processing computer 10 can receive a reply signal or message which corresponds to each polling signal or interrogation signal and store the data and/or information contained in each received reply signal or message. The central processing computer 10 can receive the reply signals or messages from each television 60, or from each cable TV box or set-top box associated with each television 60, tuned to or viewing the television channel, program, show, other content, advertisement, or commercial. Upon the completion of the broadcast or transmission of the respective television program, show, other content, advertisement, or commercial, to each television 60 or to each cable TV box or set-top box associated with each television 60, the central processing computer 10 will, at step 1003, process the data and/or information received in the reply signals or messages received from each television 60, or from each cable TV box or set-top box associated with each television 60, tuned to or viewing the television channel.

At step 1004, the central processing computer 10 will determine and assign a ratings number for the respective television program, show, other content, advertisement, or commercial.

At step 1005, data and/or information regarding the ratings number for the respective television program, show, other content, advertisement, or commercial, will be stored in the database 10H. At step 1005, data and/or information regarding the ratings number for the respective television program, show, other content, advertisement, or commercial, can also be stored in the database 30H of the ratings computer 30.

At step 1006, the ratings computer 30 can generate a ratings alert message which contains data and/or information regarding the ratings number for the respective television program, show, other content, advertisement, or commercial. In another preferred embodiment, the ratings alert message can simply contain information regarding the availability of data and/or information regarding the ratings number for the respective television program, show, other content, advertisement, or commercial.

At step 1007, the ratings computer 30 can transmit the ratings alert message in real-time, immediately, or periodically, to a respective central processing computer 10, or other computer or communication device, associated with a competitor or an affiliate of the television channel via which the respective television program, show, other content, advertisement, or commercial, was broadcast or transmitted. At step 1008, a user or operator of the respective central processing computer 10, or other computer or communication device associated with a competitor or an affiliate of the television channel from which the program, show, other content, advertisement, or commercial, was broadcast or transmitted, can access the ratings computer 30 and can be provided with the data and/or information regarding the ratings number for the respective television program, show, other content, advertisement, or commercial.

In another preferred embodiment, the above-described process of FIG. 10 can be used to report ratings to advertisers as well as content providers. Thereafter, the operation of the apparatus 100 will cease at step 1009.

In the above described manner, a television station or a television network may self-monitor its programming, programs, shows, other content, advertisements, or commercials, and self-report data and/or information regarding the ratings of same to competitors, affiliates, advertisers, and/or content providers. By receiving such ratings information, a respective party can, for example, decide to change, alter, or modify, its programming, its programming scheduling, its advertisement strategy, and/or its advertising time slot purchases or advertising slot purchases.

In another preferred embodiment, the above-described process of FIG. 10 can also be utilized to monitor and determine ratings of programming, programs, shows, other content, advertisement, or commercials, which are broadcast to or transmitted to the personal computers 70 and/or to the cellular or wireless communication devices 80 described herein, as well as any other device(s) described herein as being used by any individuals, users, customers, entities, or subscribers, described herein as being able to utilize the apparatus 100 of the present invention.

In another preferred embodiment, the apparatus 100 and method of the present invention can be utilized to provide real-time, immediate, or periodic, ratings alert messages to any of the individuals, users, customers, entities, or subscribers, described herein.

In another preferred embodiment, a ratings provider, which can include an organization or entity which performs ratings determination for television programming, programs, shows, other content, advertisements, or commercials, can, at any time, transmit, enter, and/or update, ratings data and/or information to or at the ratings computer 30 and, in particular, the database 30H, via the ratings provider communication device 35. Ratings data and/or information can be transmitted, entered, and/or updated, to or at the ratings computer 30 at any periodically and/or at any time. As noted herein, ratings data and/or information can also be provided by any central processing computer 10. Any entity or individual which or who utilizes the apparatus 100 of the present invention can request to receive a ratings alert message in real-time, immediately, and/or periodically, whenever a rating of any programming, program, show, other content, advertisement, or commercial, is entered into, updated at, and/or stored in, the database 30H.

FIG. 11 illustrates another preferred embodiment for utilizing the apparatus 100 and method of the present invention, to provide real-time, immediate, or periodic, ratings alerts, in flow diagram form. With reference to FIG. 11, the operation of the apparatus 100 commences at step 1100. At step 1101, any entity or individual may access the ratings computer 30 and/or the central processing computer 10 via a content provider communication device 25, a ratings provider communication device 35, an advertisement/marketing provider communication device 45, a television 60, a personal computer 70, or a cellular or wireless communication device 80. The entity or individual can be a content provider, a ratings provider, an advertiser or an advertising firm or agency, a marketing firm, a television station, a television network, an operator of a central processing computer 10, and/or any individual, user, customer, entity or subscriber, described herein. At step 1102, the entity or individual can enter a request to receive an alert message upon a posting of ratings information or an update to ratings information for a television program, show, other content, advertisement, or commercial.

At step 1102, the request to receive an alert message can also include a request to be notified when a rating above a selected number for any television program, show, other content, advertisement, or commercial, is posted or updated. At step 1102, the request to receive an alert message can also be for a request to be notified regarding any event relating to any rating posting or updating which may be of interest to the entity or individual.

At step 1103, information regarding the request to receive an alert message can be transmitted to, and received by, the ratings computer 30 and/or the central processing computer 10, whichever is utilized. At step 1104, the ratings computer 30 and/or the central processing computer 10, whichever is utilized, will await a posting or an updating of the ratings information of interest to the entity or individual. Upon detecting a posting or an updating of the ratings information of interest to the entity or individual, the ratings computer 30 and/or the central processing computer 10 will, at step 1105, generate the ratings alert message containing information regarding the posting or the updating of the ratings information, including the ratings information itself. At step 1106, the ratings computer 30 and/or the central processing computer 10 will transmit the ratings alert message to the content provider communication device 25, ratings provider communication device 35, advertisement/marketing provider communication device 45, television 60, personal computer 70, or cellular or wireless communication device 80 associated with or used by the requesting entity or individual.

In a preferred embodiment, the ratings alert message can be transmitted in real-time or immediately to the respective content provider communication device 25, ratings provider communication device 35, advertisement/marketing provider communication device 45, television 60, personal computer 70, or cellular or wireless communication device 80. In another preferred embodiment, the ratings alert message can be transmitted to the respective content provider communication device 25, ratings provider communication device 35, advertisement/marketing provider communication device 45, television 60, personal computer 70, or cellular or wireless communication device 80, periodically and/or at periodic intervals. At step 1107, the ratings alert message can be received by the content provider communication device 25, ratings provider communication device 35, advertisement/marketing provider communication device 45, television 60, personal computer 70, or cellular or wireless communication device 80, and the information contained in the ratings alert message can be provided to the entity or individual. Thereafter, the operation of the apparatus 100 will cease at step 1108.

In any and/or all of the embodiments described herein, any of the advertisements described herein can be utilized in connection with a link or a hyperlink thereby allowing a click-through to a merchant's or an advertiser's web site. In any and/or all of the embodiments described herein, any of the advertisements described herein can be placed in frames surrounding the viewed or viewable content and/or the broadcast or transmitted television programming, program, show, other content, advertisement, or commercial. In any and/or all of the embodiments described herein, any of the advertisements described herein can be effectuated via any suitable advertising relationship between the respective advertiser or merchant and the respective television station or television network.

In another preferred embodiment, the advertisement relationship between the respective advertiser or merchant and the respective television station or television network can include an affiliated marketing relationship, wherein the television station or television network can receive compensation and/or can receive additional compensation over and above any advertising compensation, and/or as an alternative to advertising compensation, for transactions regarding the advertised good, product, or service, purchased as a result of, or facilitated by, the advertisement placement. Applicant hereby incorporates by reference herein the subject matter and teachings of U.S. patent application Ser. No. 09/771,491, filed Jan. 27, 2001, and entitled “Apparatus and method for effectuating an affiliated marketing relationship” which, at page 23, line 11 to page 68, line 19, and in FIGS. 1, 2 3A, 3B, and 3C, teaches and discloses an apparatus and a method for effectuating, providing, and/or facilitating, an affiliated marketing relationship which can provide for the monitoring, the tracking, and/or the management, of marketing relationships, referral relationships, and/or other commerce-related and/or marketing relationships and/or activities.

Any and/or all of the products and/or services described-herein as being provided by the apparatus 100 and method of the present invention can be provided as an advertisement-based product and/or service and/or as a subscription-based products and/or service.

Applicant hereby incorporates by reference herein the subject matter and teachings of U.S. Provisional Patent Application Ser. No. 61/132,633, filed Jun. 20, 2008, and entitled “DIGITAL TELEVISION BROADCASTING APPARATUS AND METHOD FOR PROVIDING INFORMATION IN A DIGITAL TELEVISION AND INTERNET CONVERGENT ENVIRONMENT”, in their entirety.

While the present invention has been described and illustrated in various preferred and alternate embodiments, such descriptions are merely illustrative of the present invention and are not to be construed to be limitations thereof. In this regard, the present invention encompasses all modifications, variations, and/or alternate embodiments, with the scope of the present invention being limited only by the claims which follow.

What is claimed is:

1. A digital television broadcast apparatus, comprising:
a database, wherein the database stores a plurality of news stories or information which is received or obtained from any number of content providers;
a memory device, wherein the memory device stores information regarding a request by an individual to receive an alert message regarding a posting of a news story or information in the database, wherein the request to receive an alert message contains information regarding a search criteria;
a processor, wherein the processor detects a posting of a news story or information in the database, wherein the processor determines if the news story or information satisfies the search criteria and, if the search criteria is satisfied, the processor generates an alert message containing information regarding the posting or storing of the news story of information; and
a transmitter, wherein the transmitter transmits the alert message to a communication device associated with the individual.

2. The apparatus of claim 1, wherein the communication device is a television.

3. The apparatus of claim 1, wherein the communication device is a personal computer.

4. The apparatus of claim 1, wherein the communication device is a cellular telephone or a personal digital assistant.

5. The apparatus of claim 1, further comprising:
a receiver, wherein the receiver receives the news story or information from a second communication device, wherein the second communication device is associated with a content provider.

6. The apparatus of claim 1, wherein the apparatus transmits the news story or the information to the communication device or to a second communication device associated with the individual.

7. The apparatus of claim 1, wherein the processor processes a financial transaction regarding a payment for providing the news story or information to the communication device or to a second communication device associated with the individual.

8. The apparatus of claim 7, wherein the processor processes information for effecting payment to an account of a content provider who posted the news story or information.

9. A digital television broadcast apparatus, comprising:
a database, wherein the database stores a plurality of news stories or information which is received or obtained from any number of content providers;
a memory device, wherein the memory device stores information regarding a request by an individual to receive a personal news report, wherein the personal news report contains one or more news stories associated with a topic or subject specified by the individual;
a processor, wherein the processor detects a posting of a news story or news stories in the database, wherein the processor determines if the news story or news stories are associated with the topic or subject specified by the individual, and if the news story or news stories are associated with the topic or subject specified by the individual, the processor generates a personal news report containing the news story or news stories; and
a transmitter, wherein the transmitter transmits the personal news story to a communication device associated with the individual.

10. The apparatus of claim 9, wherein the processor generates an alert message containing information regarding the existence or availability of the personal news report, and further wherein the apparatus transmits the alert message to the communication device or to a second communication device associated with the individual.

11. The apparatus of claim 9, wherein the communication device is a television.

12. The apparatus of claim 9, wherein the communication device is a personal computer.

13. The apparatus of claim 9, wherein the communication device is a cellular telephone or a personal digital assistant.

14. The apparatus of claim 9, further comprising:
a receiver, wherein the receiver receives the news story or information from a second communication device, wherein the second communication device is associated with a content provider.

15. The apparatus of claim 1, wherein the apparatus stores information regarding television programming, a television program, or a television show, and further wherein the apparatus stores information regarding an adverting time slot, advertising time slots, an advertising slot, or advertising slots, in or associated with the television programming, the television program, or the television show, and further wherein the apparatus receives a request to receive information regarding an adverting time slot, advertising time slots, an advertising slot, or advertising slots, in or associated with the television programming, the television program, or the television show, and further wherein the apparatus processes the request to receive information and generates a message, in response to the request to receive information, containing information regarding an adverting time slot, advertising time slots, an advertising slot, or advertising slots, in or associated with the television programming, the television program, or the television show; and further wherein the apparatus transmits the message to a communication device associated with an advertiser.

16. The apparatus of claim 15, wherein the apparatus processes information regarding a purchase, by the advertiser, of an adverting time slot, advertising time slots, an advertising slot, or advertising slots, identified in the message.

17. The apparatus of claim 16, wherein the apparatus processes information or stores an advertisement or a commercial to be utilized in the adverting time slot, the advertising time slots, the advertising slot, or the advertising slots.

18. The apparatus of claim 15, wherein the apparatus processes information for making the adverting time slot, the advertising time slots, the advertising slot, or the advertising slots, purchased by the advertiser, available for resale.

19. The apparatus of claim 15, wherein the apparatus processes information for creating or selling an advertising option associated with, or derived from, the adverting time slot, the advertising time slots, the advertising slot, or the advertising slots.

20. The apparatus of claim 15, wherein the apparatus stores information regarding ratings information for television programming, a television program, a television show, television content, an advertisement, or a commercial, wherein the apparatus receives information regarding a posting or a storing of new ratings information or updated ratings information for the television programming, the television program, the television show, the television content, the advertisement, or the commercial, wherein the apparatus detects the posting or the storing of the new ratings information or the updated ratings information for the television programming, the television program, the television show, the television content, the advertisement, or the commercial, wherein the apparatus generates a ratings alert message in response to the posting or the storing of the new ratings information or the updated ratings information for the television programming, the television program, the television show, the television content, the advertisement, or the commercial, and further wherein the apparatus transmits the ratings alert message to a second communication device, wherein the second communication device is associated with a television station, a television network, a group of television stations, a group of television networks, a competitor of a television station or a television network, or an affiliate of a television station or a television network, or the apparatus transmits the ratings alert message to the communication device.
